(19) United States
(12) Patent Application Publication
(10) Pub. No.: US 2026/0246858 A1
(43) Pub. Date: Aug. 20, 2026

(54) METHOD AND DEVICE FOR TRANSMITTING/RECEIVING INFORMATION ABOUT RESTRICTED TARGET WAKE TIME IN WIRELESS LAN SYSTEM

(71) Applicant: LG Electronics Inc., Seoul (KR)

(72) Inventors: Sunhee BAEK, Seoul (KR); Insun JANG, Seoul (KR); Jinsoo CHOI, Seoul (KR); Geonhwan KIM, Seoul (KR); Yelin YOON, Seoul (KR)

(21) Appl. No.: 19/162,325

(22) PCT Filed: Mar. 7, 2024
(86) PCT No.: PCT/KR2024/002936

§ 371 Date: Sep. 4, 2025

(30) Foreign Application Priority Data
Mar. 7, 2023 (KR) 10-2023-0030182

(51) Int. Cl. H04L 69/323; H04W 76/40

(52) U.S. Cl. CPC H04L 69/323; H04W 76/40

(57) ABSTRACT

A method and a device for transmitting/receiving information about a restricted target wake time in a wireless LAN system are disclosed. The method performed by an STA in a wireless LAN system, according to one embodiment of the present disclosure, may comprise the steps of: receiving, from a first AP, a frame including information about an R-TWT; and transmitting or receiving a PPDU to or from a second AP on the basis of the information about the R-TWT.

### TECHNICAL FIELD

The present disclosure relates to a method and an apparatus for transmitting and receiving (schedule) information for a restricted target wake time (R-TWT) in a wireless local area network (WLAN) system.

### BACKGROUND ART

New technologies for improving transmission rates, increasing bandwidth, improving reliability, reducing errors, and reducing latency have been introduced for a wireless LAN (WLAN). Among WLAN technologies, an Institute of Electrical and Electronics Engineers (IEEE) 802.11 series standard may be referred to as Wi-Fi. For example, technologies recently introduced to WLAN include enhancements for Very High-Throughput (VHT) of the 802.11ac standard, and enhancements for High Efficiency (HE) of the IEEE 802.11ax standard.

In order to provide a more advanced wireless communication environment, improved technologies for Extremely High Throughput (EHT) are being discussed. For example, technologies for MIMO and multiple access point (AP) coordination that support increased bandwidth, efficient utilization of multiple bands, and increased spatial streams are being studied, and in particular, various technologies are being studied to support low latency or real-time traffic. Furthermore, new technologies are being discussed to support ultra high reliability (UHR), including improvements or extensions of EHT technologies.

### DISCLOSURE

### Technical Problem

A technical object of the present disclosure is to provide a method and an apparatus for transmitting and receiving (schedule) information for R-TWT.

The technical objects to be achieved by the present disclosure are not limited to the above-described technical objects, and other technical objects which are not described herein will be clearly understood by those skilled in the pertinent art from the following description.

### Technical Solution

A method performed by a station (STA) in a wireless local area network (WLAN) system according to an aspect of the present disclosure may include: receiving a frame including information for a restricted target wake time (R-TWT) from a first access point (AP); and transmitting or receiving a physical protocol data unit (PPDU) with a second AP based on the information for the R-TWT. The frame may include BSSID-related information for identifying a basic service set identifier (BSSID) corresponding to the second AP in relation to the information for the R-TWT.

A method performed by a first access point (AP) in a wireless local area network (WLAN) system according to an additional aspect of the present disclosure may include: generating a frame including information for a restricted target wake time (R-TWT) related to a second AP; and transmitting the frame. The frame may include BSSID-related information for identifying a basic service set identifier (BSSID) corresponding to the second AP in relation to the information for the R-TWT.

### Technical Effects

According to an embodiment of the present disclosure, it is possible to quickly identify whether information about R-TWT corresponds to an AP corresponding to a non-transmitted BSSID.

In addition, according to the present disclosure, it is possible to increase efficiency in the process of forming R-TWT membership for an AP corresponding to a non-transmitted BSSID based on information about R-TWT.

Effects achievable by the present disclosure are not limited to the above-described effects, and other effects which are not described herein may be clearly understood by those skilled in the pertinent art from the following description.

### BRIEF DESCRIPTION OF THE DRAWINGS

Accompanying drawings included as part of detailed description for understanding the present disclosure provide embodiments of the present disclosure and describe technical features of the present disclosure with detailed description.

FIG. 1 illustrates a block configuration diagram of a wireless communication device according to an embodiment of the present disclosure.

FIG. 2 is a diagram illustrating an exemplary structure of a WLAN system to which the present disclosure may be applied.

FIG. 3 is a diagram for describing a link setup process to which the present disclosure may be applied.

FIG. 4 is a diagram for describing a backoff process to which the present disclosure may be applied.

FIG. 5 is a diagram for describing a frame transmission operation based on CSMA/CA to which the present disclosure may be applied.

FIG. 6 is a diagram for describing an example of a frame structure used in a WLAN system to which the present disclosure may be applied.

FIG. 7 is a diagram illustrating examples of PPDUs defined in the IEEE 802.11 standard to which the present disclosure may be applied.

FIG. 8 is a diagram for describing an example of an individual TWT operation to which the present disclosure may be applied.

FIG. 9 is a diagram for describing an example of a broadcast TWT operation to which the present disclosure may be applied.

FIG. 10 is a diagram for describing an example of a TWT information element format.

FIG. 11 is a diagram for describing examples of an individual TWT parameter set field format.

FIG. 12 is a diagram for describing examples of a broadcast TWT parameter set field format.

FIG. 13 is a diagram illustrating examples of a restricted TWT parameter set field format.

FIG. 14 is a diagram illustrating a broadcast TWT parameter set field according to an embodiment of the present disclosure.

FIG. 15 illustrates an operation of an STA for a method for transmitting and receiving information about a restricted target wake time according to an embodiment of the present disclosure.

FIG. 16 illustrates an operation of an AP for a method for transmitting and receiving information about a restricted target wake time according to an embodiment of the present disclosure.

### DETAILED DESCRIPTION

Hereinafter, embodiments according to the present disclosure will be described in detail by referring to accompanying drawings. Detailed description to be disclosed with accompanying drawings is to describe exemplary embodiments of the present disclosure and is not to represent the only embodiment that the present disclosure may be implemented. The following detailed description includes specific details to provide complete understanding of the present disclosure. However, those skilled in the pertinent art knows that the present disclosure may be implemented without such specific details.

In some cases, known structures and devices may be omitted or may be shown in a form of a block diagram based on a core function of each structure and device in order to prevent a concept of the present disclosure from being ambiguous.

In the present disclosure, when an element is referred to as being “connected”, “combined” or “linked” to another element, it may include an indirect connection relation that yet another element presents therebetween as well as a direct connection relation. In addition, in the present disclosure, a term, “include” or “have”, specifies the presence of a mentioned feature, step, operation, component and/or element, but it does not exclude the presence or addition of one or more other features, stages, operations, components, elements and/or their groups.

In the present disclosure, a term such as “first”, “second”, etc. is used only to distinguish one element from other element and is not used to limit elements, and unless otherwise specified, it does not limit an order or importance, etc. between elements. Accordingly, within a scope of the present disclosure, a first element in an embodiment may be referred to as a second element in another embodiment and likewise, a second element in an embodiment may be referred to as a first element in another embodiment.

A term used in the present disclosure is to describe a specific embodiment, and is not to limit a claim. As used in a described and attached claim of an embodiment, a singular form is intended to include a plural form, unless the context clearly indicates otherwise. A term used in the present disclosure, “and/or”, may refer to one of related enumerated items or it means that it refers to and includes any and all possible combinations of two or more of them. In addition, “/” between words in the present disclosure has the same meaning as “and/or”, unless otherwise described.

Examples of the present disclosure may be applied to various wireless communication systems. For example, examples of the present disclosure may be applied to a wireless LAN system. For example, examples of the present disclosure may be applied to an IEEE 802.11a/g/n/ac/ax standards-based wireless LAN. Furthermore, examples of the present disclosure may be applied to a wireless LAN based on the newly proposed IEEE 802.11be (or EHT) standard. Examples of the present disclosure may be applied to an IEEE 802.11be Release-2 standard-based wireless LAN corresponding to an additional enhancement technology of the IEEE 802.11be Release-1 standard. Additionally, examples of the present disclosure may be applied to a next-generation standards-based wireless LAN after IEEE 802.11be. Further, examples of this disclosure may be applied to a cellular wireless communication system. For example, it may be applied to a cellular wireless communication system based on Long Term Evolution (LTE)-based technology and 5G New Radio (NR)-based technology of the 3rd Generation Partnership Project (3GPP) standard.

Hereinafter, technical features to which examples of the present disclosure may be applied will be described.

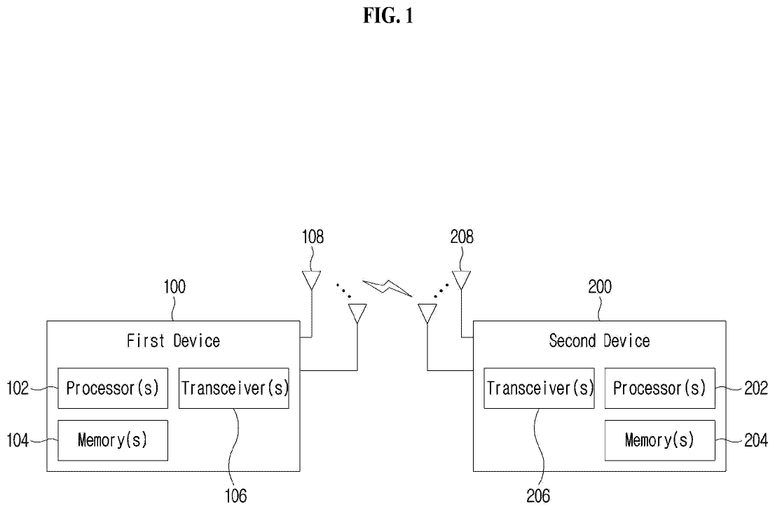

FIG. 1 illustrates a block diagram of a wireless communication device according to an embodiment of the present disclosure.

The first device 100 and the second device 200 illustrated in FIG. 1 may be replaced with various terms such as a terminal, a wireless device, a Wireless Transmit Receive Unit (WTRU), an User Equipment (UE), a Mobile Station (MS), an user terminal (UT), a Mobile Subscriber Station (MSS), a Mobile Subscriber Unit (MSU), a subscriber station (SS), an advanced mobile station (AMS), a wireless terminal (WT), or simply user, etc. In addition, the first device 100 and the second device 200 include an access point (AP), a base station (BS), a fixed station, a Node B, a base transceiver system (BTS), a network, It may be replaced with various terms such as an Artificial Intelligence (AI) system, a road side unit (RSU), a repeater, a router, a relay, and a gateway.

The devices 100 and 200 illustrated in FIG. 1 may be referred to as stations (STAs). For example, the devices 100 and 200 illustrated in FIG. 1 may be referred to by various terms such as a transmitting device, a receiving device, a transmitting STA, and a receiving STA. For example, the STAs 110 and 200 may perform an access point (AP) role or a non-AP role. That is, in the present disclosure, the STAs 110 and 200 may perform functions of an AP and/or a non-AP. When the STAs 110 and 200 perform an AP function, they may be simply referred to as APs, and when the STAs 110 and 200 perform non-AP functions, they may be simply referred to as STAs. In addition, in the present disclosure, an AP may also be indicated as an AP STA.

Referring to FIG. 1, the first device 100 and the second device 200 may transmit and receive radio signals through various wireless LAN technologies (e.g., IEEE 802.11 series). The first device 100 and the second device 200 may include an interface for a medium access control (MAC) layer and a physical layer (PHY) conforming to the IEEE 802.11 standard.

In addition, the first device 100 and the second device 200 may additionally support various communication standards (e.g., 3GPP LTE series, 5G NR series standards, etc.) technologies other than wireless LAN technology. In addition, the device of the present disclosure may be implemented in various devices such as a mobile phone, a vehicle, a personal computer, augmented reality (AR) equipment, and virtual reality (VR) equipment, etc. In addition, the STA of the present specification may support various communication services such as a voice call, a video call, data communication, autonomous-driving, machine-type communication (MTC), machine-to-machine (M2M), device-to-device (D2D), IoT (Internet-of-Things), etc.

A first device 100 may include one or more processors 102 and one or more memories 104 and may additionally include one or more transceivers 106 and/or one or more antennas 108. A processor 102 may control a memory 104 and/or a transceiver 106 and may be configured to implement description, functions, procedures, proposals, methods and/or operation flow charts disclosed in the present disclosure. For example, a processor 102 may transmit a wireless signal including first information/signal through a transceiver 106 after generating first information/signal by processing information in a memory 104. In addition, a processor 102 may receive a wireless signal including second information/signal through a transceiver 106 and then store information obtained by signal processing of second information/signal in a memory 104. A memory 104 may be connected to a processor 102 and may store a variety of information related to an operation of a processor 102. For example, a memory 104 may store a software code including instructions for performing all or part of processes controlled by a processor 102 or for performing description, functions, procedures, proposals, methods and/or operation flow charts disclosed in the present disclosure. Here, a processor 102 and a memory 104 may be part of a communication modem/circuit/chip designed to implement a wireless LAN technology (e.g., IEEE 802.11 series). A transceiver 106 may be connected to a processor 102 and may transmit and/or receive a wireless signal through one or more antennas 108. A transceiver 106 may include a transmitter and/or a receiver. A transceiver 106 may be used together with a RF (Radio Frequency) unit. In the present disclosure, a device may mean a communication modem/circuit/chip.

A second device 200 may include one or more processors 202 and one or more memories 204 and may additionally include one or more transceivers 206 and/or one or more antennas 208. A processor 202 may control a memory 204 and/or a transceiver 206 and may be configured to implement description, functions, procedures, proposals, methods and/or operation flows charts disclosed in the present disclosure. For example, a processor 202 may generate third information/signal by processing information in a memory 204, and then transmit a wireless signal including third information/signal through a transceiver 206. In addition, a processor 202 may receive a wireless signal including fourth information/signal through a transceiver 206, and then store information obtained by signal processing of fourth information/signal in a memory 204. A memory 204 may be connected to a processor 202 and may store a variety of information related to an operation of a processor 202. For example, a memory 204 may store a software code including instructions for performing all or part of processes controlled by a processor 202 or for performing description, functions, procedures, proposals, methods and/or operation flow charts disclosed in the present disclosure. Here, a processor 202 and a memory 204 may be part of a communication modem/circuit/chip designed to implement a wireless LAN technology (e.g., IEEE 802.11 series). A transceiver 206 may be connected to a processor 202 and may transmit and/or receive a wireless signal through one or more antennas 208. A transceiver 206 may include a transmitter and/or a receiver. A transceiver 206 may be used together with a RF unit. In the present disclosure, a device may mean a communication modem/circuit/chip.

Hereinafter, a hardware element of a device 100, 200 will be described in more detail. It is not limited thereto, but one or more protocol layers may be implemented by one or more processors 102, 202. For example, one or more processors 102, 202 may implement one or more layers (e.g., a functional layer such as PHY, MAC). One or more processors 102, 202 may generate one or more PDUs (Protocol Data Unit) and/or one or more SDUs (Service Data Unit) according to description, functions, procedures, proposals, methods and/or operation flow charts disclosed in the present disclosure. One or more processors 102, 202 may generate a message, control information, data or information according to description, functions, procedures, proposals, methods and/or operation flow charts disclosed in the present disclosure. One or more processors 102, 202 may generate a signal (e.g., a baseband signal) including a PDU, a SDU, a message, control information, data or information according to functions, procedures, proposals and/or methods disclosed in the present disclosure to provide it to one or more transceivers 106, 206. One or more processors 102, 202 may receive a signal (e.g., a baseband signal) from one or more transceivers 106, 206 and obtain a PDU, a SDU, a message, control information, data or information according to description, functions, procedures, proposals, methods and/or operation flow charts disclosed in the present disclosure.

One or more processors 102, 202 may be referred to as a controller, a micro controller, a micro processor or a micro computer. One or more processors 102, 202 may be implemented by a hardware, a firmware, a software, or their combination. In an example, one or more ASICs (Application Specific Integrated Circuit), one or more DSPs (Digital Signal Processor), one or more DSPDs (Digital Signal Processing Device), one or more PLDs (Programmable Logic Device) or one or more FPGAs (Field Programmable Gate Arrays) may be included in one or more processors 102, 202. Description, functions, procedures, proposals, methods and/or operation flow charts disclosed in the present disclosure may be implemented by using a firmware or a software and a firmware or a software may be implemented to include a module, a procedure, a function, etc. A firmware or a software configured to perform description, functions, procedures, proposals, methods and/or operation flow charts disclosed in the present disclosure may be included in one or more processors 102, 202 or may be stored in one or more memories 104, 204 and driven by one or more processors 102, 202. Description, functions, procedures, proposals, methods and/or operation flow charts disclosed in the present disclosure may be implemented by using a firmware or a software in a form of a code, an instruction and/or a set of instructions.

One or more memories 104, 204 may be connected to one or more processors 102, 202 and may store data, a signal, a message, information, a program, a code, an indication and/or an instruction in various forms. One or more memories 104, 204 may be configured with ROM, RAM, EPROM, a flash memory, a hard drive, a register, a cash memory, a computer readable storage medium and/or their combination. One or more memories 104, 204 may be positioned inside and/or outside one or more processors 102, 202. In addition, one or more memories 104, 204 may be connected to one or more processors 102, 202 through a variety of technologies such as a wire or wireless connection.

One or more transceivers 106, 206 may transmit user data, control information, a wireless signal/channel, etc. mentioned in methods and/or operation flow charts, etc. of the present disclosure to one or more other devices. One or more transceivers 106, 206 may receiver user data, control information, a wireless signal/channel, etc. mentioned in description, functions, procedures, proposals, methods and/or operation flow charts, etc. disclosed in the present disclosure from one or more other devices. For example, one or more transceivers 106, 206 may be connected to one or more processors 102, 202 and may transmit and receive a wireless signal. For example, one or more processors 102, 202 may control one or more transceivers 106, 206 to transmit user data, control information or a wireless signal to one or more other devices. In addition, one or more processors 102, 202 may control one or more transceivers 106, 206 to receive user data, control information or a wireless signal from one or more other devices. In addition, one or more transceivers 106, 206 may be connected to one or more antennas 108, 208 and one or more transceivers 106, 206 may be configured to transmit and receive user data, control information, a wireless signal/channel, etc. mentioned in description, functions, procedures, proposals, methods and/or operation flow charts, etc. disclosed in the present disclosure through one or more antennas 108, 208. In the present disclosure, one or more antennas may be a plurality of physical antennas or a plurality of logical antennas (e.g., an antenna port). One or more transceivers 106, 206 may convert a received wireless signal/channel, etc. into a baseband signal from a RF band signal to process received user data, control information, wireless signal/channel, etc. by using one or more processors 102, 202. One or more transceivers 106, 206 may convert user data, control information, a wireless signal/channel, etc. which are processed by using one or more processors 102, 202 from a baseband signal to a RF band signal. Therefore, one or more transceivers 106, 206 may include an (analogue) oscillator and/or a filter.

For example, one of the STAs 100 and 200 may perform an intended operation of an AP, and the other of the STAs 100 and 200 may perform an intended operation of a non-AP STA. For example, the transceivers 106 and 206 of FIG. 1 may perform a transmission and reception operation of a signal (e.g., a packet or a physical layer protocol data unit (PPDU) conforming to IEEE 802.11a/b/g/n/ac/ax/be). In addition, in the present disclosure, an operation in which various STAs generate transmission/reception signals or perform data processing or calculation in advance for transmission/reception signals may be performed by the processors 102 and 202 of FIG. 1. For example, an example of an operation of generating a transmission/reception signal or performing data processing or calculation in advance for the transmission/reception signal may include 1) determining/acquiring/configuring/calculating/decoding/encoding bit information of fields (signal (SIG), short training field (STF), long training field (LTF), Data, etc.) included in the PPDU, 2) determining/configuring/acquiring time resources or frequency resources (e.g., subcarrier resources) used for fields (SIG, STF, LTF, Data, etc.) included in the PPDU; 3) determining/configuring/acquiring a specific sequence (e.g., pilot sequence, STF/LTF sequence, extra sequence applied to SIG) used for fields (SIG, STF, LTF, Data, etc.) included in the PPDU action, 4) power control operation and/or power saving operation applied to the STA, 5) Operations related to ACK signal determination/acquisition/configuration/calculation/decoding/encoding, etc. In addition, in the following example, various information (e.g., information related to fields/subfields/control fields/parameters/power, etc.) used by various STAs to determine/acquire/configure/calculate/decode/encode transmission and reception signals may be stored in the memories 104 and 204 of FIG. 1.

Hereinafter, downlink (DL) may mean a link for communication from an AP STA to a non-AP STA, and a DL PPDU/packet/signal may be transmitted and received through the DL. In DL communication, a transmitter may be part of an AP STA, and a receiver may be part of a non-AP STA. Uplink (UL) may mean a link for communication from non-AP STAs to AP STAs, and a UL PPDU/packet/signal may be transmitted and received through the UL. In UL communication, a transmitter may be part of a non-AP STA, and a receiver may be part of an AP STA.

FIG. 2 is a diagram illustrating an exemplary structure of a wireless LAN system to which the present disclosure may be applied.

The structure of the wireless LAN system may consist of be composed of a plurality of components. A wireless LAN supporting STA mobility transparent to an upper layer may be provided by interaction of a plurality of components. A Basic Service Set (BSS) corresponds to a basic construction block of a wireless LAN. FIG. 2 exemplarily shows that two BSSs (BSS1 and BSS2) exist and two STAs are included as members of each BSS (STA1 and STA2 are included in BSS1, and STA3 and STA4 are included in BSS2). An ellipse representing a BSS in FIG. 2 may also be understood as representing a coverage area in which STAs included in the corresponding BSS maintain communication. This area may be referred to as a Basic Service Area (BSA). When an STA moves out of the BSA, it may not directly communicate with other STAs within the BSA.

If the DS shown in FIG. 2 is not considered, the most basic type of BSS in a wireless LAN is an independent BSS (IBSS). For example, IBSS may have a minimal form containing only two STAs. For example, assuming that other components are omitted, BSS1 containing only STA1 and STA2 or BSS2 containing only STA3 and STA4 may respectively correspond to representative examples of IBSS. This configuration is possible when STAs may communicate directly without an AP. In addition, in this type of wireless LAN, it is not configured in advance, but may be configured when a LAN is required, and this may be referred to as an ad-hoc network. Since the IBSS does not include an AP, there is no centralized management entity. That is, in IBSS, STAs are managed in a distributed manner. In IBSS, all STAs may be made up of mobile STAs, and access to the distributed system (DS) is not allowed, forming a self-contained network.

Membership of an STA in the BSS may be dynamically changed by turning on or off the STA, entering or exiting the BSS area, and the like. To become a member of the BSS, the STA may join the BSS using a synchronization process. In order to access all services of the BSS infrastructure, the STA shall be associated with the BSS. This association may be dynamically established and may include the use of a Distribution System Service (DSS).

A direct STA-to-STA distance in a wireless LAN may be limited by PHY performance. In some cases, this distance limit may be sufficient, but in some cases, communication between STAs at a longer distance may be required. A distributed system (DS) may be configured to support extended coverage.

DS means a structure in which BSSs are interconnected. Specifically, as shown in FIG. 2, a BSS may exist as an extended form of a network composed of a plurality of BSSs. DS is a logical concept and may be specified by the characteristics of Distributed System Media (DSM). In this regard, a wireless medium (WM) and a DSM may be logically separated. Each logical medium is used for a different purpose and is used by different components. These medium are not limited to being the same, nor are they limited to being different. In this way, the flexibility of the wireless LAN structure (DS structure or other network structure) may be explained in that a plurality of media are logically different. That is, the wireless LAN structure may be implemented in various ways, and the corresponding wireless LAN structure may be independently specified by the physical characteristics of each embodiment.

A DS may support a mobile device by providing seamless integration of a plurality of BSSs and providing logical services necessary to address an address to a destination. In addition, the DS may further include a component called a portal that serves as a bridge for connection between the wireless LAN and other networks (e.g., IEEE 802.X).

The AP enables access to the DS through the WM for the associated non-AP STAs, and means an entity that also has the functionality of an STA. Data movement between the BSS and the DS may be performed through the AP. For example, STA2 and STA3 shown in FIG. 2 have the functionality of STAs, and provide a function allowing the associated non-AP STAs (STA1 and STA4) to access the DS. In addition, since all APs basically correspond to STAs, all APs are addressable entities. The address used by the AP for communication on the WM and the address used by the AP for communication on the DSM are not necessarily the same. A BSS composed of an AP and one or more STAs may be referred to as an infrastructure BSS.

Data transmitted from one of the STA(s) associated with an AP to a STA address of the corresponding AP may be always received on an uncontrolled port and may be processed by an IEEE 802.1X port access entity. In addition, when a controlled port is authenticated, transmission data (or frames) may be delivered to the DS.

In addition to the structure of the DS described above, an extended service set (ESS) may be configured to provide wide coverage.

An ESS means a network in which a network having an arbitrary size and complexity is composed of DSs and BSSs. The ESS may correspond to a set of BSSs connected to one DS. However, the ESS does not include the DS. An ESS network is characterized by being seen as an IBSS in the Logical Link Control (LLC) layer. STAs included in the ESS may communicate with each other, and mobile STAs may move from one BSS to another BSS (within the same ESS) transparently to the LLC. APs included in one ESS may have the same service set identification (SSID). The SSID is distinguished from the BSSID, which is an identifier of the BSS.

The wireless LAN system does not assume anything about the relative physical locations of BSSs, and all of the following forms are possible. BSSs may partially overlap, which is a form commonly used to provide continuous coverage. In addition, BSSs may not be physically connected, and logically there is no limit on the distance between BSSs. In addition, the BSSs may be physically located in the same location, which may be used to provide redundancy. In addition, one (or more than one) IBSS or ESS networks may physically exist in the same space as one (or more than one) ESS network. When an ad-hoc network operates in a location where an ESS network exists, when physically overlapping wireless networks are configured by different organizations, or when two or more different access and security policies are required in the same location, this may correspond to the form of an ESS network in the like.

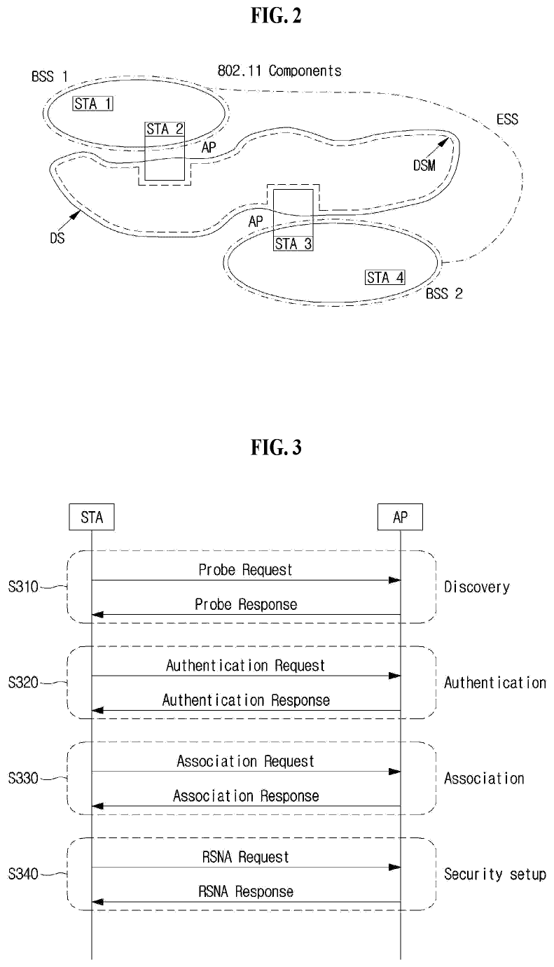

FIG. 3 is a diagram for explaining a link setup process to which the present disclosure may be applied.

In order for an STA to set up a link with respect to a network and transmit/receive data, it first discovers a network, performs authentication, establishes an association, and need to perform the authentication process for security. The link setup process may also be referred to as a session initiation process or a session setup process. In addition, the processes of discovery, authentication, association, and security setting of the link setup process may be collectively referred to as an association process.

In step S310, the STA may perform a network discovery operation. The network discovery operation may include a scanning operation of the STA. That is, in order for the STA to access the network, it needs to find a network in which it can participate. The STA shall identify a compatible network before participating in a wireless network, and the process of identifying a network existing in a specific area is called scanning.

Scanning schemes include active scanning and passive scanning. FIG. 3 exemplarily illustrates a network discovery operation including an active scanning process. In active scanning, an STA performing scanning transmits a probe request frame to discover which APs exist around it while moving channels and waits for a response thereto. A responder transmits a probe response frame as a response to the probe request frame to the STA that has transmitted the probe request frame. Here, the responder may be an STA that last transmitted a beacon frame in the BSS of the channel being scanned. In the BSS, since the AP transmits the beacon frame, the AP becomes a responder, and in the IBSS, the STAs in the IBSS rotate to transmit the beacon frame, so the responder is not constant. For example, a STA that transmits a probe request frame on channel 1 and receives a probe response frame on channel 1, may store BSS-related information included in the received probe response frame and may move to the next channel (e.g., channel 2) and perform scanning (i.e., transmission/reception of a probe request/response on channel 2) in the same manner.

Although not shown in FIG. 3, the scanning operation may be performed in a passive scanning manner. In passive scanning, a STA performing scanning waits for a beacon frame while moving channels. The beacon frame is one of the management frames defined in IEEE 802.11, and is periodically transmitted to notify the existence of a wireless network and to allow the STA performing scanning to find a wireless network and participate in the wireless network. In the BSS, the AP serves to transmit beacon frames periodically, and in the IBSS, STAs within the IBSS rotate to transmit beacon frames. When the STA performing scanning receives a beacon frame, the STA stores information for the BSS included in the beacon frame and records beacon frame information in each channel while moving to another channel. The STA receiving the beacon frame may store BSS-related information included in the received beacon frame, move to the next channel, and perform scanning in the next channel in the same way. Comparing active scanning and passive scanning, active scanning has an advantage of having less delay and less power consumption than passive scanning.

After the STA discovers the network, an authentication process may be performed in step S320. This authentication process may be referred to as a first authentication process in order to be clearly distinguished from the security setup operation of step S340 to be described later.

The authentication process includes a process in which the STA transmits an authentication request frame to the AP, and in response to this, the AP transmits an authentication response frame to the STA. An authentication frame used for authentication request/response corresponds to a management frame.

The authentication frame includes an authentication algorithm number, an authentication transaction sequence number, a status code, a challenge text, a robust security network (RSN), and a Finite Cyclic Group, etc. This corresponds to some examples of information that may be included in the authentication request/response frame, and may be replaced with other information or additional information may be further included.

The STA may transmit an authentication request frame to the AP. The AP may determine whether to allow authentication of the corresponding STA based on information included in the received authentication request frame. The AP may provide the result of the authentication process to the STA through an authentication response frame.

After the STA is successfully authenticated, an association process may be performed in step S330. The association process includes a process in which the STA transmits an association request frame to the AP, and in response, the AP transmits an association response frame to the STA.

For example, the association request frame may include information related to various capabilities, a beacon listen interval, a service set identifier (SSID), supported rates, supported channels, RSN, mobility domain, supported operating classes, Traffic Indication Map Broadcast request (TIM broadcast request), interworking service capability, etc. For example, the association response frame may include information related to various capabilities, status code, association ID (AID), supported rates, enhanced distributed channel access (EDCA) parameter set, received channel power indicator (RCPI), received signal to noise indicator (RSNI), mobility domain, timeout interval (e.g., association comeback time), overlapping BSS scan parameters, TIM broadcast response, Quality of Service (QoS) map, etc. This corresponds to some examples of information that may be included in the association request/response frame, and may be replaced with other information or additional information may be further included.

After the STA is successfully associated with the network, a security setup process may be performed in step S340. The security setup process of step S340 may be referred to as an authentication process through Robust Security Network Association (RSNA) request/response, and the authentication process of step S320 is referred to as a first authentication process, and the security setup process of step S340 may also simply be referred to as an authentication process.

The security setup process of step S340 may include, for example, a process of setting up a private key through 4-way handshaking through an Extensible Authentication Protocol over LAN (EAPOL) frame. In addition, the security setup process may be performed according to a security scheme not defined in the IEEE 802.11 standard.

FIG. 4 is a diagram for explaining a backoff process to which the present disclosure may be applied.

In the wireless LAN system, a basic access mechanism of medium access control (MAC) is a carrier sense multiple access with collision avoidance (CSMA/CA) mechanism. The CSMA/CA mechanism is also called Distributed Coordination Function (DCF) of IEEE 802.11 MAC, and basically adopts a “listen before talk” access mechanism. According to this type of access mechanism, the AP and/or STA may perform Clear Channel Assessment (CCA) sensing a radio channel or medium during a predetermined time interval (e.g., DCF Inter-Frame Space (DIFS)), prior to starting transmission. As a result of the sensing, if it is determined that the medium is in an idle state, frame transmission is started through the corresponding medium. On the other hand, if it is detected that the medium is occupied or busy, the corresponding AP and/or STA does not start its own transmission and may set a delay period for medium access (e.g., a random backoff period) and attempt frame transmission after waiting. By applying the random backoff period, since it is expected that several STAs attempt frame transmission after waiting for different periods of time, collision may be minimized.

In addition, the IEEE 802.11 MAC protocol provides a Hybrid Coordination Function (HCF). HCF is based on the DCF and Point Coordination Function (PCF). PCF is a polling-based synchronous access method and refers to a method in which all receiving APs and/or STAs periodically poll to receive data frames. In addition, HCF has Enhanced Distributed Channel Access (EDCA) and HCF Controlled Channel Access (HCCA). EDCA is a contention-based access method for a provider to provide data frames to multiple users, and HCCA uses a non-contention-based channel access method using a polling mechanism. In addition, the HCF includes a medium access mechanism for improving QoS (Quality of Service) of the wireless LAN, and may transmit QoS data in both a Contention Period (CP) and a Contention Free Period (CFP).

Referring to FIG. 4, an operation based on a random backoff period will be described. When the occupied/busy medium changes to an idle state, several STAs may attempt to transmit data (or frames). As a method for minimizing collisions, each of STAs may respectively select a random backoff count and attempt transmission after waiting for a corresponding slot time. The random backoff count has a pseudo-random integer value and may be determined as one of values ranging from 0 to CW. Here, CW is a contention window parameter value. The CW parameter is given CWmin as an initial value, but may take a value twice as large in case of transmission failure (e.g., when an ACK for the transmitted frame is not received). When the CW parameter value reaches CWmax, data transmission may be attempted while maintaining the CWmax value until data transmission is successful, and when data transmission is successful, the CWmin value is reset. The values of CW, CWmin and CWmax are preferably set to 2n−1 (n=0, 1, 2, . . . ).

When the random backoff process starts, the STA continuously monitors the medium while counting down the backoff slots according to the determined backoff count value. When the medium is monitored for occupancy, it stops counting down and waits, and resumes the rest of the countdown when the medium becomes idle.

In the example of FIG. 4, when a packet to be transmitted arrives at the MAC of STA3, STA3 may transmit the frame immediately after confirming that the medium is idle as much as DIFS. The remaining STAs monitor and wait for the medium to be occupied/busy. In the meantime, data to be transmitted may also occur in each of STA1, STA2, and STA5, and each STA waits as long as DIFS when the medium is monitored as idle, and then may perform a countdown of the backoff slot according to the random backoff count value selected by each STA. Assume that STA2 selects the smallest backoff count value and STA1 selects the largest backoff count value. That is, the case where the remaining back-off time of STA5 is shorter than the remaining back-off time of STA1 at the time when STA2 completes the back-off count and starts frame transmission is exemplified. STA1 and STA5 temporarily stop counting down and wait while STA2 occupies the medium. When the occupation of STA2 ends and the medium becomes idle again, STA1 and STA5 wait for DIFS and resume the stopped backoff count. That is, frame transmission may be started after counting down the remaining backoff slots for the remaining backoff time. Since the remaining backoff time of STA5 is shorter than that of STA1, STA5 starts frame transmission. While STA2 occupies the medium, data to be transmitted may also occur in STA4. From the standpoint of STA4, when the medium becomes idle, STA4 may wait for DIFS, and then may perform a countdown according to the random backoff count value selected by the STA4 and start transmitting frames. The example of FIG. 4 shows a case where the remaining backoff time of STA5 coincides with the random backoff count value of STA4 by chance. In this case, a collision may occur between STA4 and STA5. When a collision occurs, both STA4 and STA5 do not receive an ACK, so data transmission fails. In this case, STA4 and STA5 may double the CW value, select a random backoff count value, and perform a countdown. STA1 waits while the medium is occupied due to transmission of STA4 and STA5, waits for DIFS when the medium becomes idle, and then starts frame transmission after the remaining backoff time has elapsed.

As in the example of FIG. 4, the data frame is a frame used for transmission of data forwarded to a higher layer, and may be transmitted after a backoff performed after DIFS elapses from when the medium becomes idle. Additionally, the management frame is a frame used for exchange of management information that is not forwarded to a higher layer, and is transmitted after a backoff performed after an IFS such as DIFS or Point Coordination Function IFS (PIFS). As a subtype frames of management frame, there are a Beacon, an association request/response, a re-association request/response, a probe request/response, an authentication request/response, etc. A control frame is a frame used to control access to a medium. As a subtype frames of control frame, there are Request-To-Send (RTS), Clear-To-Send (CTS), Acknowledgement (ACK), Power Save-Poll (PS-Poll), block ACK (BlockAck), block ACK request (BlockACKReq), null data packet announcement (NDP announcement), and trigger, etc. If the control frame is not a response frame of the previous frame, it is transmitted after backoff performed after DIFS elapses, and if it is a response frame of the previous frame, it is transmitted without performing backoff after short IFS (SIFS) elapses. The type and subtype of the frame may be identified by a type field and a subtype field in a frame control (FC) field.

A Quality of Service (QoS) STA may perform the backoff that is performed after an arbitration IFS (AIFS) for an access category (AC) to which the frame belongs, that is, AIFS[i] (where i is a value determined by AC), and then may transmit the frame. Here, the frame in which AIFS[i] can be used may be a data frame, a management frame, or a control frame other than a response frame.

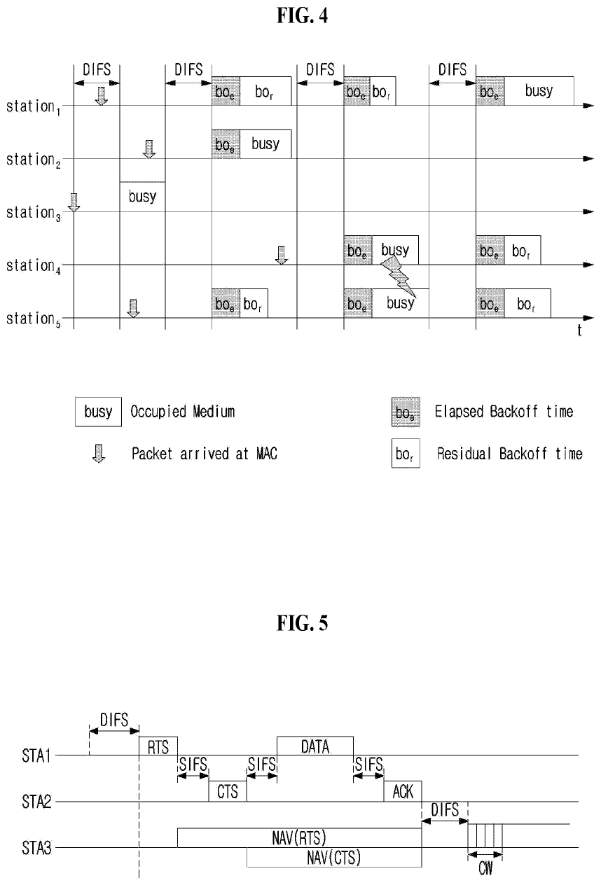

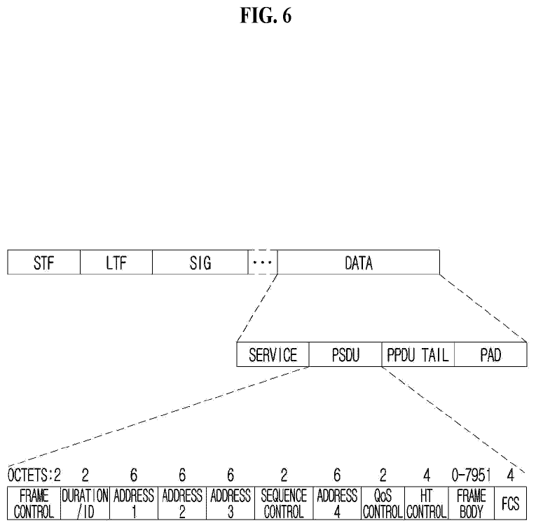

FIG. 5 is a diagram for explaining a frame transmission operation based on CSMA/CA to which the present disclosure may be applied.

As described above, the CSMA/CA mechanism includes virtual carrier sensing in addition to physical carrier sensing in which a STA directly senses a medium. Virtual carrier sensing is intended to compensate for problems that may occur in medium access, such as a hidden node problem. For virtual carrier sensing, the MAC of the STA may use a Network Allocation Vector (NAV). The NAV is a value indicating, to other STAs, the remaining time until the medium is available for use by an STA currently using or having the right to use the medium. Therefore, the value set as NAV corresponds to a period in which the medium is scheduled to be used by the STA transmitting the frame, and the STA receiving the NAV value is prohibited from accessing the medium during the corresponding period. For example, the NAV may be configured based on the value of the “duration” field of the MAC header of the frame.

In the example of FIG. 5, it is assumed that a STA1 intends to transmit data to a STA2, and a STA3 is in a position capable of overhearing some or all of frames transmitted and received between the STA1 and the STA2.

In order to reduce the possibility of collision of transmissions of multiple STAs in CSMA/CA based frame transmission operation, a mechanism using RTS/CTS frames may be applied. In the example of FIG. 5, while transmission of the STA1 is being performed, as a result of carrier sensing of the STA3, it may be determined that the medium is in an idle state. That is, the STA1 may correspond to a hidden node to the STA3. Alternatively, in the example of FIG. 5, it may be determined that the carrier sensing result medium of the STA3 is in an idle state while transmission of the STA2 is being performed. That is, the STA2 may correspond to a hidden node to the STA3. Through the exchange of RTS/CTS frames before performing data transmission and reception between the STA1 and the STA2, a STA outside the transmission range of one of the STA1 or the STA2, or a STA outside the carrier sensing range for transmission from the STA1 or the STA3 may not attempt to occupy the channel during data transmission and reception between the STA1 and the STA2.

Specifically, the STA1 may determine whether a channel is being used through carrier sensing. In terms of physical carrier sensing, the STA1 may determine a channel occupation idle state based on an energy level or signal correlation detected in a channel. In addition, in terms of virtual carrier sensing, the STA1 may determine a channel occupancy state using a network allocation vector (NAV) timer.

The STA1 may transmit an RTS frame to the STA2 after performing a backoff when the channel is in an idle state during DIFS. When the STA2 receives the RTS frame, the STA2 may transmit a CTS frame as a response to the RTS frame to the STA1 after SIFS.

If the STA3 cannot overhear the CTS frame from the STA2 but can overhear the RTS frame from the STA1, the STA3 may set a NAV timer for a frame transmission period (e.g., SIFS+CTS frame+SIFS+data frame+SIFS+ACK frame) that is continuously transmitted thereafter, using the duration information included in the RTS frame. Alternatively, if the STA3 can overhear a CTS frame from the STA2 although the STA3 cannot overhear an RTS frame from the STA1, the STA3 may set a NAV timer for a frame transmission period (e.g., SIFS+data frame+SIFS+ACK frame) that is continuously transmitted thereafter, using the duration information included in the CTS frame. That is, if the STA3 can overhear one or more of the RTS or CTS frames from one or more of the STA1 or the STA2, the STA3 may set the NAV accordingly. When the STA3 receives a new frame before the NAV timer expires, the STA3 may update the NAV timer using duration information included in the new frame. The STA3 does not attempt channel access until the NAV timer expires.

When the STA1 receives the CTS frame from the STA2, the STA1 may transmit the data frame to the STA2 after SIFS from the time point when the reception of the CTS frame is completed. When the STA2 successfully receives the data frame, the STA2 may transmit an ACK frame as a response to the data frame to the STA1 after SIFS. The STA3 may determine whether the channel is being used through carrier sensing when the NAV timer expires. When the STA3 determines that the channel is not used by other terminals during DIFS after expiration of the NAV timer, the STA3 may attempt channel access after a contention window (CW) according to a random backoff has passed.

FIG. 6 is a diagram for explaining an example of a frame structure used in a WLAN system to which the present disclosure may be applied.

By means of an instruction or primitive (meaning a set of instructions or parameters) from the MAC layer, the PHY layer may prepare a MAC PDU (MPDU) to be transmitted. For example, when a command requesting transmission start of the PHY layer is received from the MAC layer, the PHY layer switches to the transmission mode and configures information (e.g., data) provided from the MAC layer in the form of a frame and transmits it. In addition, when the PHY layer detects a valid preamble of the received frame, the PHY layer monitors the header of the preamble and sends a command notifying the start of reception of the PHY layer to the MAC layer.

In this way, information transmission/reception in a wireless LAN system is performed in the form of a frame, and for this purpose, a PHY layer protocol data unit (PPDU) frame format is defined.

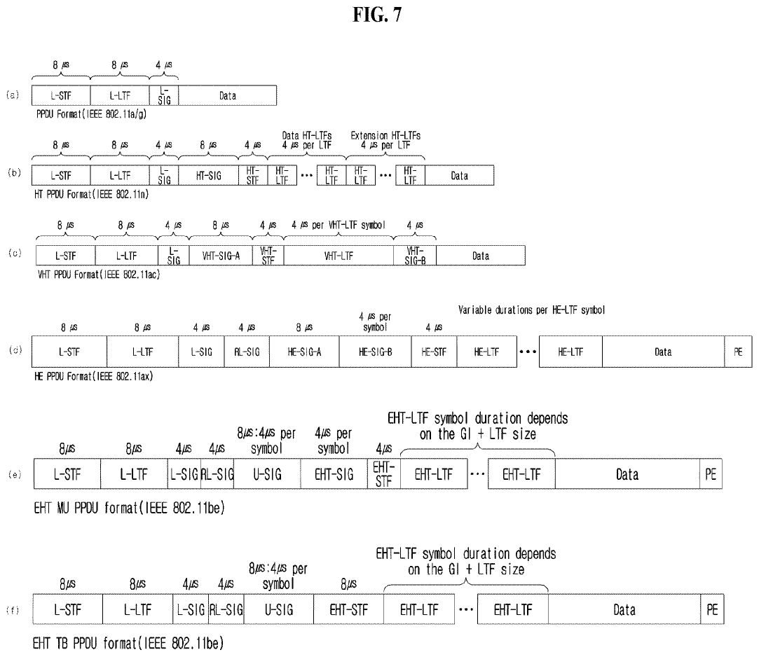

A basic PPDU may include a Short Training Field (STF), Long Training Field (LTF), SIGNAL (SIG) field, and Data (Data) field. The most basic PPDU format (e.g., non-HT (High Throughput) shown in FIG. 7) may consist of only the Legacy-STF (L-STF), Legacy-LTF (L-LTF), Legacy-SIG (L-SIG) fields, and data fields. Additionally, depending on the type of PPDU format (e.g., HT-mixed format PPDU, HT-greenfield format PPDU, VHT (Very High Throughput) PPDU, etc.), additional (or different types) of RL-SIG, U-SIG, non-legacy SIG fields, non-legacy STF, non-legacy LTF (i.e., xx-SIG, xx-STF, xx-LTF (e.g. xx is HT, VHT, HE, EHT, etc.)), etc. may be included between the L-SIG field and the data field.

The STF is a signal for signal detection, automatic gain control (AGC), diversity selection, precise time synchronization, and the like, and the LTF is a signal for channel estimation and frequency error estimation. The STF and LTF may be referred to as signals for synchronization and channel estimation of the OFDM physical layer.

The SIG field may include various information related to PPDU transmission and reception. For example, the L-SIG field consists of 24 bits and the L-SIG field may include 4-bit Rate field, 1-bit Reserved bit, 12-bit Length field, 1-bit Parity field, and 6-bit Tail field. The RATE field may include information about the modulation and coding rate of data. For example, the 12-bit Length field may include information about the length or time duration of the PPDU. For example, the value of the 12-bit Length field may be determined based on the type of PPDU. For example, for non-HT, HT, VHT, or EHT PPDU, the value of the Length field may be determined to be a multiple of 3. For example, for a HE PPDU, the value of the Length field may be determined as a multiple of 3+1 or a multiple of 3+2.

The data field may include a SERVICE field, a physical layer service data unit (PSDU), and a PPDU TAIL bit, and may also include padding bits if necessary. Some bits of the SERVICE field may be used for synchronization of the descrambler at the receiving end. The PSDU corresponds to the MAC PDU defined in the MAC layer, and may include data generated/used in the upper layer. The PPDU TAIL bit may be used to return the encoder to a 0 state. Padding bits may be used to adjust the length of a data field in a predetermined unit.

A MAC PDU is defined according to various MAC frame formats, and a basic MAC frame consists of a MAC header, a frame body, and a Frame Check Sequence (FCS). The MAC frame may consist of MAC PDUs and be transmitted/received through the PSDU of the data part of the PPDU frame format.

The MAC header includes a Frame Control field, a Duration/ID field, an Address field, and the like. The frame control field may include control information required for frame transmission/reception. The duration/ID field may be set to a time for transmitting a corresponding frame or the like. For details of the Sequence Control, QoS Control, and HT Control subfields of the MAC header, refer to the IEEE 802.11 standard document.

The null-data PPDU (NDP) format refers to a PPDU format that does not include a data field. In other words, NDP refers to a frame format that includes the PPDU preamble in a general PPDU format (i.e., L-STF, L-LTF, L-SIG fields, and additionally non-legacy SIG, non-legacy STF, non-legacy LTF if present) and does not include the remaining part (i.e., data field).

FIG. 7 is a diagram illustrating examples of PPDUs defined in the IEEE 802.11 standard to which the present disclosure may be applied.

In standards such as IEEE 802.11a/g/n/ac/ax, various types of PPDUs have been used. The basic PPDU format (IEEE 802.11a/g) includes L-LTF, L-STF, L-SIG and Data fields. The basic PPDU format may also be referred to as a non-HT PPDU format (as shown in FIG. 7(a)).

The HT PPDU format (IEEE 802.11n) additionally includes HT-SIG, HT-STF, and HT-LFT(s) fields to the basic PPDU format. The HT PPDU format shown in FIG. 7(b) may be referred to as an HT-mixed format. In addition, an HT-greenfield format PPDU may be defined, and this corresponds to a format consisting of HT-GF-STF, HT-LTF1, HT-SIG, one or more HT-LTF, and Data field, not including L-STF, L-LTF, and L-SIG (not shown).

An example of the VHT PPDU format (IEEE 802.11ac) additionally includes VHT SIG-A, VHT-STF, VHT-LTF, and VHT-SIG-B fields to the basic PPDU format (as shown in FIG. 7(c)).

An example of the HE PPDU format (IEEE 802.11ax) additionally includes Repeated L-SIG (RL-SIG), HE-SIG-A, HE-SIG-B, HE-STF, HE-LTF(s), Packet Extension (PE) field to the basic PPDU format (as shown in FIG. 7(d)). Some fields may be excluded or their length may vary according to detailed examples of the HE PPDU format. For example, the HE-SIG-B field is included in the HE PPDU format for multi-user (MU), and the HE-SIG-B is not included in the HE PPDU format for single user (SU). In addition, the HE trigger-based (TB) PPDU format does not include the HE-SIG-B, and the length of the HE-STF field may vary to 8 μs. The Extended Range (HE ER) SU PPDU format does not include the HE-SIG-B field, and the length of the HE-SIG-A field may vary to 16 us. For example, RL-SIG may be configured the same as L-SIG. The receiving STA can know that the received PPDU is a HE PPDU or an EHT PPDU, which will be described later, based on the presence of the RL-SIG.

The EHT PPDU format may include the EHT MU (multi-user) in FIG. 7(e) and the EHT TB (trigger-based) PPDU in FIG. 7(f). The EHT PPDU format is similar to the HE PPDU format in that it includes RL-SIG followed by L-SIG, but may include U (universal)-SIG, EHT-SIG, EHT-STF, and EHT-LTF following RL-SIG.

The EHT MU PPDU in FIG. 7(e) corresponds to a PPDU carrying one or more data (or PSDU) for one or more users. That is, the EHT MU PPDU may be used for both SU transmission and MU transmission. For example, the EHT MU PPDU may correspond to a PPDU for one receiving STA or multiple receiving STAs.

The EHT TB PPDU in FIG. 7(f) omits the EHT-SIG compared to the EHT MU PPDU. An STA that receives a trigger (e.g., trigger frame or triggered response scheduling (TRS)) for UL MU transmission may perform UL transmission based on the EHT TB PPDU format.

L-STF, L-LTF, L-SIG, RL-SIG, U-SIG (Universal SIGNAL), EHT-SIG fields may be encoded and modulated so that even legacy STAs may attempt demodulation and decoding, and may be mapped based on a determined subcarrier frequency interval (e.g., 312.5 kHz). These may be referred to as pre-EHT modulated fields. Next, the EHT-STF, EHT-LTF, Data, PE fields may be encoded and modulated to be demodulated and decoded by an STA that successfully decodes the non-legacy SIG (e.g., U-SIG and/or EHT-SIG) and obtains the information included in the field, and may be mapped based on a determined subcarrier frequency interval (e.g., 78.125 kHz). These may be referred to as EHT modulated fields.

Similarly, in the HE PPDU format, the L-STF, L-LTF, L-SIG, RL-SIG, HE-SIG-A, and HE-SIG-B fields may be referred to as pre-HE modulation fields, and the HE-STF, HE-LTF, Data, and PE fields may be referred to as HE modulation fields. Additionally, in the VHT PPDU format, the L-STF, L-LTF, L-SIG, and VHT-SIG-A fields may be referred to as free VHT modulation fields, and VHT STF, VHT-LTF, VHT-SIG-B, and Data fields may be referred to as VHT modulation fields.

The U-SIG included in the EHT PPDU format of FIG. 7 may be configured based on, for example, two symbols (e.g., two consecutive OFDM symbols). Each symbol (e.g., OFDM symbol) for U-SIG may have a duration of 4 us, and U-SIG may have a total duration of 8 us. Each symbol of U-SIG may be used to transmit 26 bits of information. For example, each symbol of U-SIG can be transmitted and received based on 52 data tones and 4 pilot tones.

U-SIG may be constructed in units of 20 MHz. For example, if an 80 MHz PPDU is constructed, the U-SIG may be duplicated. That is, the same 4 U-SIGs may be included in the 80 MHz PPDU. PPDUs exceeding 80 MHz bandwidth may include different U-SIGs.

For example, A number of uncoded bits may be transmitted through U-SIG, the first symbol of U-SIG (e.g., U-SIG-1 symbol) may transmit the first X bits of information out of the total A bits of information, and the second symbol of U-SIG (e.g., U-SIG-2 symbol) may transmit the remaining Y bit information of the total A bit information. A-bit information (e.g., 52 uncoded bits) may include a CRC field (e.g., a 4-bit long field) and a tail field (e.g., a 6-bit long field). For example, the tail field may be used to terminate the trellis of the convolutional decoder and may be set to 0.

A bit information transmitted by U-SIG may be divided into version-independent bits and version-dependent bits. For example, U-SIG may be included in a new PPDU format not shown in FIG. 7 (e.g., UHR PPDU format), and in the format of the U-SIG field included in the EHT PPDU format and the format of the U-SIG field included in the UHR PPDU format, version-independent bits may be the same, and some or all of the version-dependent bits may be different.

For example, the size of the version-independent bits of U-SIG may be fixed or variable. Version-independent bits may be assigned only to the U-SIG-1 symbol, or to both the U-SIG-1 symbol and the U-SIG-2 symbol. Version-independent bits and version-dependent bits may be called various names, such as first control bit and second control bit.

For example, the version-independent bits of U-SIG may include a 3-bit physical layer version identifier (PHY version identifier), and this information may indicate the PHY version (e.g., EHT, UHR, etc.) of the transmitted/received PPDU. The version-independent bits of U-SIG may include a 1-bit UL/DL flag field. The first value of the 1-bit UL/DL flag field is related to UL communication, and the second value of the UL/DL flag field is related to DL communication. The version-independent bits of U-SIG may include information about the length of transmission opportunity (TXOP) and information about the BSS color ID.

For example, the version-dependent bits of U-SIG may include information directly or indirectly indicating the type of PPDU (e.g., SU PPDU, MU PPDU, TB PPDU, etc.).

Information necessary for PPDU transmission and reception may be included in U-SIG. For example, U-SIG may further include information about whether information on bandwidth, information on the MCS technique applied to the non-legacy SIG (e.g., EHT-SIG or UHR-SIG, etc.), information indicating whether the DCM (dual carrier modulation) technique (e.g., a technique to achieve an effect similar to frequency diversity by reusing the same signal on two subcarriers) is applied to the non-legacy SIG, information on the number of symbols used for the non-legacy SIG, non-legacy SIG is generated across the entire band.

Some of the information required for PPDU transmission and reception may be included in U-SIG and/or non-legacy SIG (e.g., EHT-SIG or UHR-SIG, etc.). For example, information on the type of non-legacy LTF/STF (e.g., EHT-LTF/EHT-STF or UHR-LTF/UHR-STF, etc.), information on the length of the non-legacy LTF and CP (cyclic prefix) length, information on GI (guard interval) applicable to non-legacy LTF, information on preamble puncturing applicable to PPDU, information on RU (resource unit) allocation, etc. may be included only in the U-SIG, only in the non-legacy SIG, or may be indicated by a combination of information included in the U-SIG and information included in the non-legacy SIG.

Preamble puncturing may mean transmission of a PPDU in which a signal does not exist in one or more frequency units among the bandwidth of the PPDU. For example, the size of the frequency unit (or resolution of preamble puncturing) may be defined as 20 MHz, 40 MHz, etc. For example, preamble puncturing may be applied to a PPDU bandwidth of a predetermined size or more.

In the example of FIG. 7, non-legacy SIGs such as HE-SIG-B and EHT-SIG may include control information for the receiving STA. A non-legacy SIG may be transmitted over at least one symbol, and one symbol may have a length of 4 us. Information about the number of symbols used for the EHT-SIG may be included in previous SIGs (e.g., HE-SIG-A, U-SIG, etc.).

Non-legacy SIGs such as HE-SIG-B and EHT-SIG may include common fields and user-specific fields. Common fields and user-specific fields may be coded separately.

In some cases, common fields may be omitted. For example, in a compression mode where non-OFDMA (orthogonal frequency multiple access) is applied, the common field may be omitted, and multiple STAs may receive a PPDU (e.g., a data field of the PPDU) through the same frequency band. In a non-compressed mode where OFDMA is applied, multiple users may receive a PPDU (e.g., a data field of the PPDU) through different frequency bands.

The number of user-specific fields may be determined based on the number of users. One user block field may include up to two user fields. Each user field may be associated with a MU-MIMO allocation or may be associated with a non-MU-MIMO allocation.

The common field may include a CRC bit and a Tail bit, and the length of the CRC bit may be determined to be 4 bits, and the length of the Tail bit may be determined to be 6 bits and set to 000000. The common field may include RU allocation information. RU allocation information may include information about the location of the RU to which multiple users (i.e., multiple receiving STAs) are assigned.

RU may include multiple subcarriers (or tones). RU may be used when transmitting signals to multiple STAs based on OFDMA technique. Additionally, RU may be defined even when transmitting a signal to one STA. Resources may be allocated in RU units for non-legacy STF, non-legacy LTF, and Data fields.

An RU of applicable size may be defined according to the PPDU bandwidth. RU may be defined identically or differently for the applied PPDU format (e.g., HE PPDU, EHT PPDU, UHR PPDU, etc.). For example, in the case of 80 MHz PPDU, the RU placement of HE PPDU and EHT PPDU may be different. applicable RU size, number of RU, and RU location for each PPDU bandwidth, DC (direct current) subcarrier location and number, null subcarrier location and number, guard subcarrier location and number, etc. may be referred to as a tone-plan. For example, a tone-plan for high bandwidth may be defined in the form of multiple iterations of a low-bandwidth tone-plan.

RUs of various sizes may be defined as 26-tone RU, 52-tone RU, 106-tone RU, 242-tone RU, 484-tone RU, 996-tone RU, 2×996-tone RU, 3×996-tone RU, etc. MRU (multiple RU) is distinguished from a plurality of individual RUs and corresponds to a group of subcarriers composed of a plurality of RUs. For example, one MRU may be defined as 52+26-tone, 106+26-tone, 484+242-tone, 996+484-tone, 996+484+242-tone, 2×996+484-tone, 3×996-tone, or 3×996+484-tone. Additionally, a plurality of RUs constituting one MRU may or may not be continuous in the frequency domain.

The specific size of the RU may be reduced or expanded. Accordingly, the specific size of each RU (i.e., the number of corresponding tones) in the present disclosure is not limiting and is illustrative. Additionally, in the present disclosure, within a predetermined bandwidth (e.g., 20, 40, 80, 160, 320 MHz, . . . ), the number of RUs may vary depending on the RU size.

The names of each field in the PPDU formats of FIG. 7 are exemplary, and the scope of the present disclosure is not limited by the names. In addition, examples of the present disclosure may be applied to the PPDU format illustrated in FIG. 7 as well as to a new PPDU format in which some fields are excluded and/or some fields are added based on the PPDU formats of FIG. 7.

### Tartget Wake Time (TWT)

A TWT is a power saving (PS) technology which may improve energy efficiency of non-AP STAs by defining a service period (SP) between an AP and non-AP STA and sharing information about a SP each other to reduce media contention. A STA which performs a request/a suggest/a demand, etc. in a TWT setup step may be referred to as a TWT requesting STA. In addition, an AP which responds to a corresponding request such as Accept/Reject, etc. may be referred to as a TWT responding STA. A setup step may include a TWT request for an AP of a STA, a type of a TWT operation performed and a process of determining/defining a frame type transmitted or received. A TWT operation may be divided into an individual TWT and a broadcast TWT.

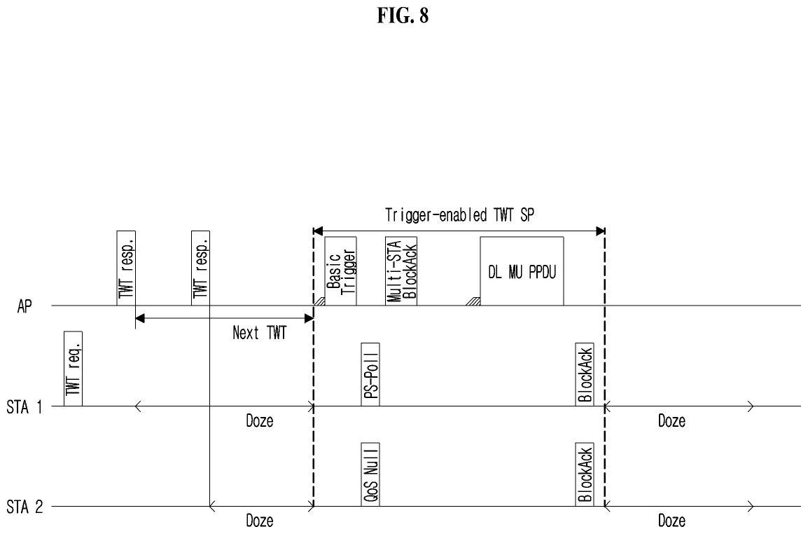

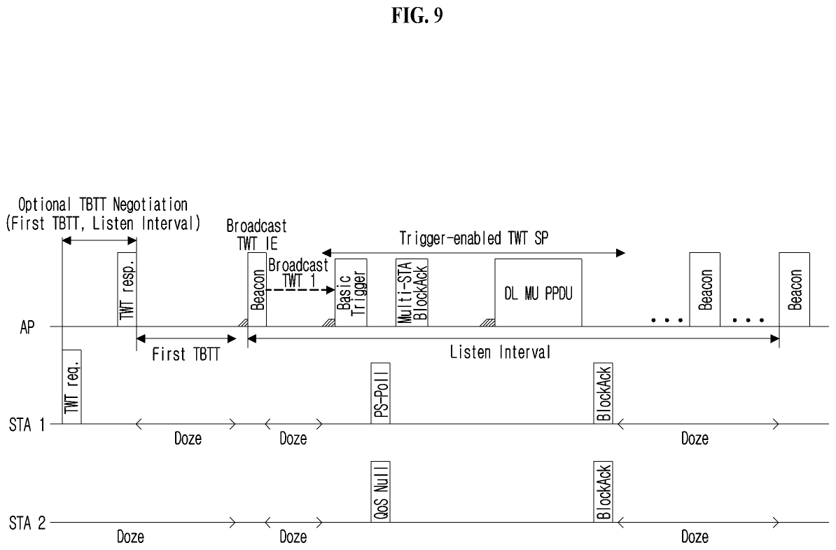

FIG. 8 is a diagram for describing an example of an individual TWT operation to which the present disclosure may be applied.

An individual TWT is a mechanism that an AP and non-AP STA perform data exchange after performing negotiation for an awake/doze status of a non-AP STA through transmission or reception of a TWT request/response frame. In an example of FIG. 8, an AP and STA1 may form a trigger-enabled TWT agreement through a TWT request frame and a TWT response frame. Here, a method used by STA1 is a solicited TWT method, which is a method that when STA1 transmits a TWT request frame to an AP, STA1 receives information for a TWT operation from an AP through a TWT response frame. On the other hand, STA2 which performs an unsolicited TWT method may receive information on a trigger-enabled TWT agreement configuration from an AP through an unsolicited TWT response. Specifically, STA2 may calculate a next TWT by adding a specific number from a current TWT value. During a trigger-enabled TWT SP, an AP may transmit a trigger frame to STAs. The trigger frame may inform STAs that an AP has buffered data. In response to it, STA1 may inform an AP of its awake status by transmitting a PS-Poll frame. In addition, STA2 may inform an AP of its awake status by transmitting a QoS Null frame. Here, a data frame transmitted by STA1 and STA2 may be a frame in a TB PPDU form. An AP which confirmed a status of STA1 and STA2 may transmit a DL MU PPDU to awake STAs. When a corresponding TWT SP expires, STA1 and STA2 may switch to a doze status.

FIG. 9 is a diagram for describing an example of a broadcast TWT operation to which the present disclosure may be applied.

A broadcast TWT is a TWT that a non-AP STA (or a TWT scheduling STA) acquires information on a target beacon transmission time (TBTT) and a listen interval, etc. by transmitting or receiving a TWT request/response frame with an AP (or a TWT scheduled STA). Here, a negotiation operation for a TBTT may be performed. Based on it, an AP may define a frame which will include scheduling information of a TWT through a beacon frame. In FIG. 9, STA1 performs a solicited TWT operation and STA2 performs an unsolicited TWT operation. An AP may transmit a DL MU PPDU after confirming an awake status of STAs through a trigger transmitted by an AP. It may be the same as a process of an individual TWT. In a broadcast TWT, a trigger-enabled TWT SP including a beacon frame may be repeated several times at a certain interval.

Delivery of TWT information may be performed through a TWT information frame and a TWT information element. A TWT information frame is transmitted by a STA to request or deliver information on a TWT agreement and is transmitted by one of STAs in an existing TWT agreement. An action frame of a TWT Information frame includes a TWT information field. A TWT Information field may include a 3-bit TWT flow identifier subfield, a 1-bit response requested subfield, a 1-bit next TWT request subfield, a 2-bit next TWT subfield size subfield, a 1-bit all TWT subfield and a 0/32/48/64-bit next TWT subfield.

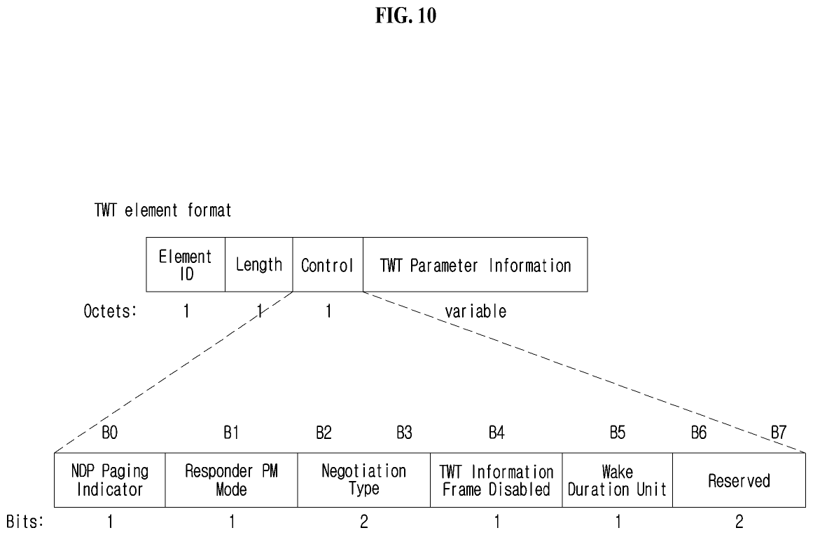

FIG. 10 is a diagram for describing an example of a TWT information element format.

A TWT information element may be transmitted or received by being included in a beacon, a probe response, a (re) association response frame, etc. A TWT information element may include an element ID field, a length field, a control field and a TWT parameter information field.

A control field of a TWT information element has the same format regardless of an individual TWT and a broadcast TWT.

A NDP paging indication subfield may have a value of 1 when a NDP paging field exists and may have a value of 0 when a NDP paging field does not exist.

A responder PM mode subfield may represent a power management (PM) mode.

A negotiation type subfield may represent whether information included in a TWT element is about a negotiation of broadcast TWT or individual TWT(s) or is about a wake TBTT interval.

For example, when a value of a negotiation type subfield is 0, a TWT subfield is about a future individual TWT SP start time and a TWT element includes one individual TWT parameter set. It may correspond to an individual TWT negotiation between a TWT requesting STA and a TWT responding STA or may correspond to an individual TWT announcement by a TWT responder.

For example, when a value of a negotiation type subfield is 1, a TWT subfield is about a next TBTT time and a TWT element includes one individual TWT parameter set. It may correspond to a wake TBTT and a wake interval negotiation between a TWT scheduled STA and a TWT scheduling AP.

For example, when a value of a negotiation type subfield is 2, a TWT subfield is about a future broadcast TWT SP start time and a TWT element includes at least one broadcast TWT parameter set. It may correspond to providing a broadcast TWT schedule to a TWT scheduled STA by including a TWT element in a broadcast management frame transmitted by a TWT scheduling AP.

For example, when a value of a negotiation type subfield is 3, a TWT subfield is about a future broadcast TWT SP start time and a TWT element includes at least one broadcast TWT parameter set. It may correspond to managing membership of a broadcast TWT schedule by including a TWT element in an individually addressed management frame transmitted by any one of a TWT scheduled STA or a TWT scheduling AP.

When a TWT information frame disabled subfield is configured as 1, it represents that reception of a TWT information frame by a STA is disabled and otherwise, it may be configured as 0.

A wake duration unit subfield represents a unit of a nominal minimum TWT wake duration field. A wake duration unit subfield may be configured as 0 when a unit is 256 us and may be configured as 1 when a unit is a TU. When it is not a HE/EHT STA, a wake duration unit subfield may be configured as 0.

A most significant bit (MSB) of a negotiation type field may correspond to a broadcast field. When the broadcast field is 1, at least one broadcast TWT parameter set may be included in a TWT element. When the broadcast field is 0, only one individual TWT parameter set may be included in a TWT element. A TWT element that the broadcast field is configured as 1 may be referred to as a broadcast TWT element.

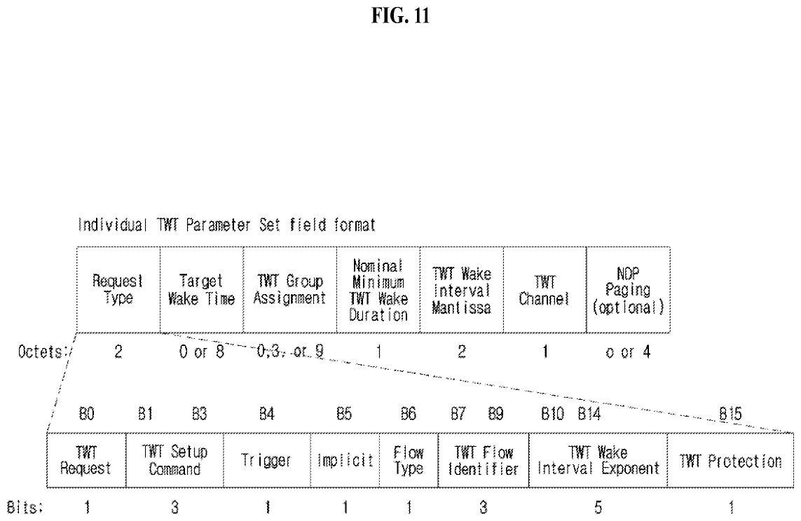

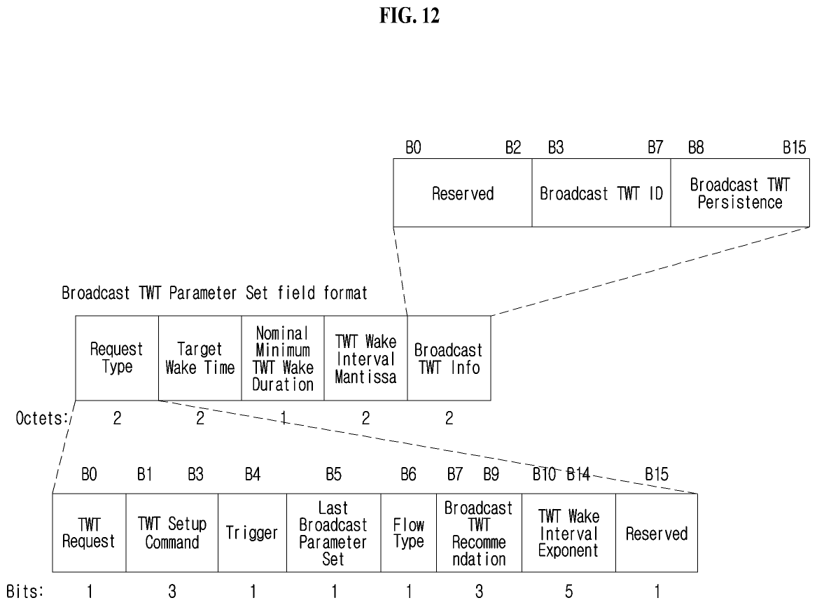

FIG. 11 is a diagram for describing examples of an individual TWT parameter set field format. FIG. 12 is a diagram for describing examples of a broadcast TWT parameter set field format.

A TWT parameter information field included in a TWT element in FIG. 10 may have a different configuration according to an individual TWT or a broadcast TWT.

For an individual TWT, a TWT parameter information field in a TWT element includes a single individual TWT parameter set field.

For a broadcast TWT, a TWT parameter information field in a TWT element includes at least one broadcast TWT parameter set field. Each broadcast TWT parameter set may include specific information on one broadcast TWT.

As shown in FIGS. 11 and 12, an individual TWT parameter set field and a broadcast TWT parameter set field include common subfields.

A request type subfield has the same size in an individual TWT parameter set field and a broadcast TWT parameter set field, but may have a different detailed configuration. It is described later.

A target wake time subfield represents a start time of an individual/broadcast TWT SP expected in the future.

A nominal minimum TWT wake duration subfield represents the minimum unit that a TWT requesting STA is expected to be awaken in order to complete frame exchange related to a TWT flow identifier during a TWT wake interval duration. Here, a TWT wake interval may mean an average time between contiguous TWT SPs expected by a TWT requesting STA.

A TWT Wake Interval Mantissa subfield is a binary value of a TWT wake interval value, which may be indicated in microseconds.

In reference to FIG. 11, a TWT group assignment subfield, a TWT channel and a NDP paging subfield are included only in an individual TWT parameter set field.

A TWT group assignment subfield is provided to a TWT requesting STA by including information on a TWT group to which a STA is assigned. A TWT value in a TWT group may be calculated by using corresponding information. A TWT value of a STA may be the same as a value obtained by multiplying a value of a zero offset and a value of a TWT offset by a value of a TWT unit.

A TWT channel subfield represents a bitmap representing an allowed channel. When transmitted by a TWT requesting STA, a TWT channel subfield may include a bitmap representing a channel which is requested by a STA to be used as a temporary basic channel during a TWT SP. When transmitted by a TWT response STA, a TWT channel subfield may include a bitmap representing a channel that a TWT request is allowed.

A NDP paging subfield is optional and may include an identifier of a paged STA, information related to the maximum number of TWT wake intervals between NDP paging frames, etc.

In reference to FIG. 12, a broadcast TWT information (broadcast TWT info) subfield is included only in a broadcast TWT parameter set field. A broadcast TWT information subfield may include a 3-bit reserved bit, a 5-bit broadcast TWT identifier (ID) subfield and a 8-bit broadcast TWT persistence subfield. A broadcast TWT identifier subfield represents a broadcast ID of a specific broadcast TWT that a STA requests participation or provides a TWT parameter according to a value of a TWT setup command subfield of a TWT element. A broadcast TWT persistence subfield represents the number of TBTTs planned on a schedule of a broadcast TWT. Next, a detailed configuration of a request type subfield is described.

First, a format of a request type subfield of an individual TWT parameter set field is described by referring to FIG. 11.

A TWT request subfield may represent whether it is a requesting STA or a response STA. When that value is 1, it may represent that it is a TWT requesting STA or a scheduling STA and when that value is 0, it may represent that it is a TWT responding STA or a scheduling AP.

A TWT setup command subfield may represent a command such as Request, Suggest, Demand, Accept, Alternate, Dictate, Reject, etc.

A trigger subfield represents whether a trigger frame will be used in a TWT SP. When that value is 1, a trigger may be used and when that value is 0, a trigger may not be used.

An implicit subfield may represent whether it is an implicit TWT or an explicit TWT. When that value is 1, it may represent an implicit TWT and when that value is 0, it may represent an explicit TWT.

A flow type subfield may represent an interaction type between a TWT requesting STA (or a TWT scheduled STA) and a TWT responding STA (or a TWT scheduling AP). When that value is 1, it may mean an announced TWT that a STA transmits a wakeup signal to an AP by transmitting a PS-Poll or automatic power save delivery (APSD) trigger frame before a frame, not a trigger frame, is transmitted from an AP to a STA. When that value is 0, it may mean an unannounced TWT.

A TWT flow identifier subfield may include a 3-bit value which uniquely identifies specific information on a corresponding TWT request in other request performed between the same TWT requesting STA and TWT responding STA pair.

A TWT wake interval exponent subfield may configure a TWT wake interval value in a binary microsecond unit. For an individual TWT, it may mean an interval between individual TWT SPs. A TWT wake interval of a requesting STA may be defined as [TWT Wake Interval Mantissa*2*TWT Wake Interval Exponent].

A TWT protection subfield may represent whether to use a TWT protection mechanism. When that value is 1, a TXOP in a TWT SP may be started with a NAV protection mechanism such as a (MU) RTS/CTS or a CTS-to-self frame and when that value is 0, a NAV protection mechanism may not be applied.

In reference to FIG. 12, some of subfields of a request type subfield of a broadcast TWT parameter set field are common with subfields of a request type subfield of an individual TWT parameter set field, so a description thereof is omitted. Subfields included only in a broadcast TWT parameter set are described below.

A last broadcast parameter set subfield represents whether it is a last broadcast TWT parameter set. When that value is 1, it may represent that it is a last broadcast TWT parameter set and when that value is 0, it may represent that a next broadcast TWT parameter set exists.

A broadcast TWT recommendation subfield may represent recommendations for a frame type transmitted by an AP during a broadcast TWT SP as a value of 1-7.

A last 1 bit of a request type subfield of a broadcast TWT parameter set field may be reserved.

Method for transmitting and receiving PPDU based on restricted target wake time (R-TWT)

Restricted TWT (R-TWT) refers to TWT with enhanced medium access reporting and resource reservation for latency-sensitive traffic delivery. An R-TWT service period (SP) refers to a time period negotiated using the R-TWT setup that prioritizes the delivery of latency-sensitive traffic.

R-TWT membership is established in the same method as broadcast TWT membership, except that the broadcast TWT element(s) carried in the management frame used to establish membership include one or more restricted TWT parameter set fields.

When an STA is an R-TWT scheduled STA and requests to establish R-TWT membership, a value of the broadcast TWT recommendation subfield in the broadcast TWT parameter set field illustrated in FIG. 12 may be set to 4.

Table 1 illustrates the broadcast TWT recommendation subfields for the broadcast TWT element.

TABLE 1

| Broadcast TWT | |
|---|---|
| Recommendation | |
| field value | Description when transmitted in a broadcast TWT element |
| . . . | . . . |
| 4 | The corresponding broadcast TWT SP is referred to as an R-TWT SP. |
| | During an R-TWT SP, the AP and member R-TWT scheduled STAs prioritize their transmission |
| | of QoS Data frames that are latency sensitive traffic (see 35.8 (Restricted TWT (R- |
| | TWT))). |
| [symbol] | Reserved |

Referring to Table 1, if the broadcast TWT recommendation indicates a value of 4 among 0 to 7, the broadcast TWT SP is referred to as an R-TWT SP. Additionally, during an R-TWT SP, the AP and member R-TWT scheduled STAs prioritize the transmission of QoS data frames, which are latency-sensitive traffic.

If the value of the broadcast TWT recommendation subfield is 4, as described above, the broadcast TWT parameter set field illustrated in FIG. 12 is referred to as a “restricted TWT parameter set field.”

Additionally, a broadcast TWT element that includes only restricted TWT parameter set field(s) (i.e., a TWT element illustrated in FIG. 10 that includes the broadcast TWT parameter set field(s) illustrated in FIG. 12) is also referred to as a ‘restricted TWT element.’

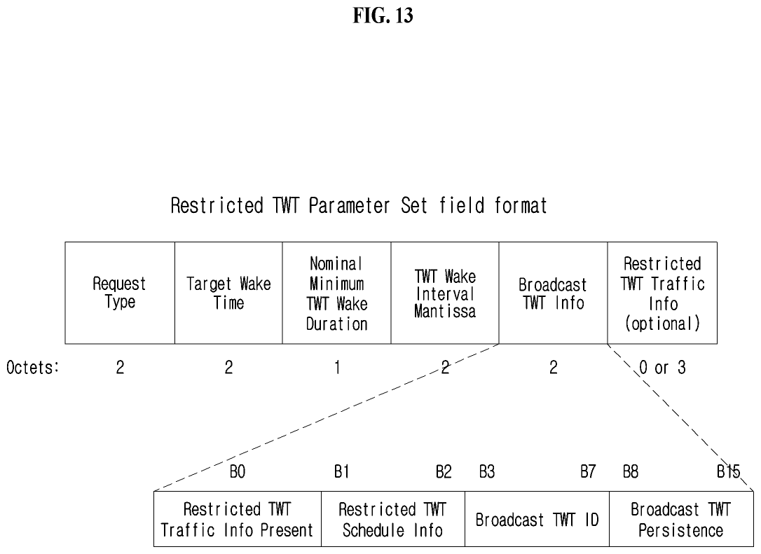

FIG. 13 is a diagram illustrating examples of a restricted TWT parameter set field format.

Referring to FIG. 13, compared to the broadcast TWT parameter set field of FIG. 12, the broadcast TWT info subfield in the restricted TWT parameter set field may be configured to include a 1-bit restricted TWT traffic info present subfield, a 2-bit restricted TWT schedule info subfield, a 5-bit broadcast TWT ID subfield, and an 8-bit broadcast TWT persistence subfield.

Regarding the differences from the broadcast TWT parameter set field of FIG. 12, the restricted TWT traffic info present subfield is set to 1 if the restricted TWT traffic info subfield is present in the restricted TWT parameter set field. Otherwise, it is set to 0.

The restricted TWT schedule info subfield is configured as described in Table 2 below when included in the restricted TWT parameter set field conveyed within a TWT element with the negotiation type subfield (see FIG. 10) set to 2.

Table 2 illustrates restricted TWT schedule info subfield values.

TABLE 2

| Restricted TWT | |
|---|---|
| Schedule Info | |
| subfield value | Description when included in a Restricted TWT Parameter Set field |
| 0 | The corresponding R-TWT schedule does not have any member STAs or the schedule is |
| | suspended for all the member STAs. |
| | Such an R-TWT schedule is referred to as an idle R-TWT schedule. |
| 1 | The corresponding R-TWT schedule has at least one member STA for which the schedule is |
| | not suspended. |
| | Such an R-TWT schedule is referred to as an active R-TWT schedule. |
| 2 | Indicates an active R-TWT schedule for which the R-TWT scheduling AP is unlikely to |
| | accept a request from a STA in the BSS to establish a new membership. |
| | Such an R-TWT schedule is referred to as a full R-TWT schedule (i.e., the AP might not |
| | have sufficient resources within this schedule for accepting new memberships). |
| 3 | Indicates that the advertised R-TWT schedule is active and is for an AP corresponding to a |
| | nontransmitted BSSID that is a member of the same multiple BSSID set or co-hosted BSSID |
| | set as the AP transmitting the Restricted TWT Schedule Info subfield. |

Referring to Table 2, if a value of the restricted TWT schedule info subfield is 0, it indicates that the corresponding R-TWT schedule does not have any member STAs or that the corresponding R-TWT schedule is suspended for all member STAs. Such an R-TWT schedule may be referred to as an idle R-TWT schedule.

If the restricted TWT schedule info subfield has a value of 1, this indicates that the corresponding R-TWT schedule has at least one member STA whose schedule is not reserved. Such an R-TWT schedule may be referred to as an active R-TWT schedule.

If the restricted TWT schedule info subfield has a value of 2, this indicates an active R-TWT schedule in which the R-TWT scheduling AP is unlikely to accept a request from an STA within the BSS to establish a new membership. Such an R-TWT schedule may be referred to as a full R-TWT schedule. That is, the AP may not have sufficient resources within the schedule to accept a new membership.

If the restricted TWT schedule info subfield has a value of 3, it indicates that the advertised R-TWT schedule is active and is for an AP corresponding to a non-transmitted BSSID that is a member of the same multiple BSSID set or co-hosted BSSID set as the AP transmitting the restricted TWT schedule info subfield.

Referring to FIG. 13, the restricted TWT parameter set field may optionally further include a restricted TWT traffic info field related to latency-sensitive traffic, compared to the broadcast TWT parameter set field of FIG. 12.

An R-TWT scheduling AP and an R-TWT scheduling STA configure a restricted TWT traffic info subfield to identify traffic identifiers (TIDs) that carry latency-sensitive traffic in the DL and UL for the established R-TWT membership. The TIDs indicated as latency-sensitive traffic in the DL and UL in the restricted TWT traffic info subfield belong to the TID sets mapped to the DL and UL, respectively, of the link for which the R-TWT membership is established.

An R-TWT scheduling AP or a member R-TWT scheduled STA that initiates or participates in frame exchange during an R-TWT SP must ensure that QoS data frames with R-TWT TID(s) are delivered first during the R-TWT SP.

If an R-TWT scheduling AP has an R-TWT membership set up, the R-TWT schedule information is announced by including the restricted TWT parameter set(s) in the broadcast TWT element included in the transmitted management frame.

Here, if the AP does not correspond to a non-transmitted BSSID, it may be announced by the R-TWT scheduling AP. Alternatively, if the R-TWT scheduling AP corresponds to a non-transmitted BSSID within the same multiple BSSID set, it may be announced by the AP corresponding to the transmitted BSSID within the same multiple BSSID set.

The transmitted BSSID refers to the BSSID included in the MAC header Address 2 field of the beacon frame when the multi-BSSID capability is supported.

Additionally, the non-transmitted BSSID refers to one of the BSSs that is not explicitly transmitted when the multi-BSSID capability is supported, but can be derived from information encoded in the probe response, beacon frame, and/or neighbor report.

In addition, multi-BSSID capability refers to the ability to advertise information about multiple BSSIDs using a single beacon or probe response frame instead of multiple beacon or probe response frames, and also refers to the ability to indicate buffered frames for the multiple BSSIDs using a single beacon or traffic indication map (TIM) element within a single TIM frame. Here, each of the multiple BSSIDs refers to a single BSSID.

In addition, a multi-BSSID set refers to a set of APs where all APs use a common operating class, channel, receive antenna connector, and transmit antenna connector, and advertise information about multiple BSSIDs using beacon or probe response frames transmitted by the AP corresponding to the transmitted BSSID.

As described above, according to the 802.11be standard, information related to the R-TWT (Restricted TWT) schedule scheduled by the AP corresponding to the non-transmitted BSSID and the AP corresponding to the transmitted BSSID is transmitted by the AP corresponding to the transmitted BSSID in the beacon frame and probe response frame.

As described above, information regarding whether the R-TWT schedule information was scheduled by the AP corresponding to the non-transmitted BSSID or the AP corresponding to the transmitted BSSID can be indicated by the restricted TWT schedule info subfield of the broadcast TWT parameter set field (i.e., the restricted TWT parameter set field) within the TWT element. The restricted TWT schedule info subfield can be located in the broadcast TWT info subfield in the restricted TWT parameter set field, as illustrated in the example of FIG. 13.

In addition, as described above, the restricted TWT schedule info subfield may have a value corresponding to Table 2. For example, if a value of the broadcast TWT recommendation subfield is 4 (see Table 1), the restricted TWT schedule info subfield may have a value corresponding to Table 2. That is, whether or not an STA is scheduled for R-TWT by an AP corresponding to the transmitted BSSID can be determined through the value of the restricted TWT schedule info subfield within the broadcast TWT info subfield when the value of the broadcast TWT recommendation subfield is 4.

Referring again to Table 2, a value of 1 or 2 in the restricted TWT schedule info subfield may indicate that the R-TWT schedule information is scheduled by an AP corresponding to the transmitted BSSID. Additionally, a value of 3 in the restricted TWT schedule info subfield may indicate that the R-TWT schedule information is scheduled by an AP corresponding to a non-transmitted BSSID.

After establishing an association with an AP corresponding to a non-transmitted BSSID, an STA can determine the R-TWT schedule information scheduled by the AP corresponding to the non-transmitted BSSID based on the beacon frame transmitted by the AP corresponding to the transmitted BSSID.

However, according to the technology defined in the 802.11be standard, the restricted TWT schedule info subfield can only determine whether the R-TWT schedule information included in the TWT element was scheduled by the AP corresponding to the non-transmitted BSSID.

More specifically, according to the 802.11be standard, when an AP corresponding to a transmitted BSSID advertises an R-TWT schedule for a non-transmitted BSSID within the same multiple BSSID set, the AP corresponding to the transmitted BSSID must include both (i) and (ii) in the advertisement.

(i) A restricted TWT parameter set field describing an R-TWT schedule in a broadcast TWT element transmitted in a non-transmitted BSSID profile of a non-transmitted BSSID in a multiple BSSID element: wherein the restricted TWT schedule info subfield is configured to one of 0, 1, or 2 (see Table 2). Additionally, the broadcast TWT ID subfield is configured to the TWT ID for the R-TWT schedule.

(ii) A restricted TWT parameter set field describing an R-TWT schedule transmitted in a broadcast TWT element outside of a multiple BSSID element when the R-TWT schedule is active: wherein the restricted TWT schedule info subfield is configured to 3 (see Table 2). Additionally, the broadcast TWT ID subfield is configured to 31.

Therefore, the STA can recognize that the R-TWT schedule is scheduled by the AP corresponding to the transmitted BSSID or non-transmitted BSSID through the restricted TWT schedule info subfield in the broadcast TWT element (i.e., the restricted TWT parameter set field in the broadcast TWT element outside the multiple BSSID element) in the beacon frame. If it is indicated that the R-TWT schedule (i.e., the R-TWT SP) is scheduled by the AP corresponding to the non-transmitted BSSID, the STA must confirm which non-transmitted BSSID the R-TWT schedule (i.e., the R-TWT SP) is by the AP through the multiple BSSID element (i.e., the restricted TWT parameter set field in the broadcast TWT element within the multiple BSSID element)

In other words, if an STA associated with an AP corresponding to a transmitted BSSID recognizes that the R-TWT SP is scheduled by an AP corresponding to a non-transmitted BSSID in the TWT element, it may not request the R-TWT membership even without reading the multiple BSSID element.

On the other hand, if an STA associated with an AP corresponding to a non-transmitted BSSID recognizes that the TWT element is an R-TWT SP scheduled by the AP corresponding to the non-transmitted BSSID, the STA must read the multiple BSSID element to determine whether the AP includes the non-transmitted BSSID to which it belongs. In other words, the STA must read the restricted TWT parameter set field in the broadcast TWT element within the multiple BSSID element to determine whether the AP corresponds to the non-transmitted BSSID to which it belongs. This has the disadvantage of decreasing efficiency as the processing load increases.

Accordingly, the present disclosure proposes a method for identifying which AP has scheduled an R-TWT schedule when the AP corresponding to the transmitted BSSID includes R-TWT schedule information scheduled by the AP corresponding to the non-transmitted BSSID in a beacon frame or probe response frame (or includes R-TWT schedule information scheduled by both the AP corresponding to the transmitted BSSID and the AP corresponding to the non-transmitted BSSID). This method allows for identifying which AP has scheduled an R-TWT schedule.

Hereinafter, in the description of the present disclosure, the present disclosure is not limited to the described values/names (e.g., values and names of fields/subfields) and the proposed method of the present disclosure can be equally applied by changing the values/names to other values/names. Furthermore, in the present disclosure, STAs may include non-AP STAs and AP STAs.

The present disclosure proposes a signaling method that includes non-transmitted BSSID information for a scheduled AP in R-TWT schedule information (i.e., a broadcast TWT parameter set field) scheduled by an AP corresponding to a non-transmitted BSSID announced by an AP corresponding to a transmitted BSSID.

Furthermore, the present disclosure proposes a signaling method that includes non-transmitted BSSID information for the scheduled AP in the R-TWT schedule information (i.e., the second broadcast TWT parameter set field) scheduled by the AP corresponding to the non-transmitted BSSID among the R-TWT schedule information (i.e., the first broadcast TWT parameter set field) scheduled by the AP corresponding to the transmitted BSSID announced by the AP corresponding to the transmitted BSSID and the R-TWT schedule information (i.e., the second broadcast TWT parameter set field) scheduled by the AP corresponding to the non-transmitted BSSID.

An AP corresponding to a transmitted BSSID may announce information related to all R-TWT SPs (Service Periods)/schedules scheduled by the AP corresponding to the transmitted BSSID and/or the AP corresponding to a non-transmitted BSSID by including the information in a beacon frame (or probe response frame). That is, one or more R-TWT scheduling information (e.g., information related to R-TWT SPs) (i.e., a broadcast TWT parameter set field) may be included in a TWT element in the beacon frame (or probe response frame). As described above, if the value of the broadcast TWT recommendation subfield in the broadcast TWT parameter set field is set to 4, the broadcast TWT parameter set field may be referred to/regarded as a restricted TWT parameter set. In addition, if only restricted TWT parameter set field(s) are included in the TWT element, the TWT element may be referred to/regarded as a restricted TWT element.

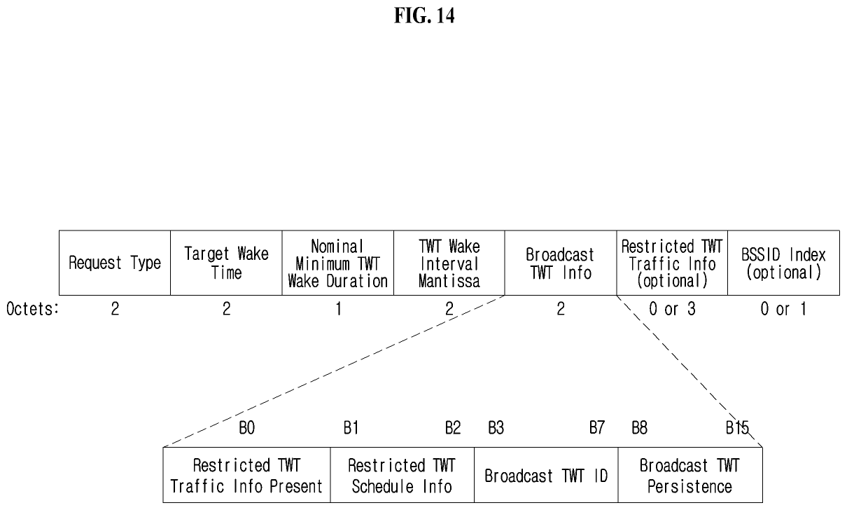

FIG. 14 is a diagram illustrating a broadcast TWT parameter set field according to an embodiment of the present disclosure.

For convenience of explanation, FIG. 14 illustrates a single broadcast TWT parameter set field. However, the present disclosure is not limited thereto. As described above, multiple broadcast TWT parameter set fields may be included within a TWT element, and the proposed method of the present disclosure may be applied equally to multiple broadcast TWT parameter set fields. Furthermore, the broadcast TWT parameter set field illustrated in FIG. 14 may be referred to/considered a restricted TWT parameter set field.

Referring to FIG. 14, a BSSID index subfield may be included in the broadcast TWT parameter set field. Subfields other than the BSSID index are identical to those described in FIG. 13 and therefore, their descriptions are omitted. Furthermore, a restricted TWT traffic info subfield may optionally be included in the broadcast TWT parameter set field proposed in the present disclosure.

In addition, for convenience of explanation, FIG. 14 assumes that the BSSID index subfield is positioned last. However, the present disclosure is not limited thereto, and the BSSID index subfield may be positioned differently in the broadcast TWT parameter set field than in FIG. 14. For example, the BSSID index subfield may be positioned before the restricted TWT traffic info subfield.

The BSSID index subfield may be configured to a value that identifies a non-transmitted BSSID for an AP that has scheduled R-TWT schedule information in the corresponding broadcast TWT parameter set field. The BSSID index subfield exemplified in FIG. 1 may be defined in the same way as the method of configuring a value that identifies a non-transmitted BSSID in the BSSID index subfield in multiple BSSID-Index elements. For example, the BSSID index subfield proposed in the present disclosure can indicate a value from 1 to 2n−1 (where n is an integer greater than 0) that identifies a non-transmitted BSSID. Alternatively, the BSSID index subfield proposed in the present disclosure can be defined differently from the way in which a value that can identify a non-transmitted BSSID is configured in the BSSID index subfield within multiple BSSID-Index elements. That is, although the BSSID index subfield is illustrated as having a length of 1 octet for convenience of explanation in FIG. 14, the present disclosure is not limited thereto and can be defined to have a different length.

The BSSID Index subfield may be included only when the AP that scheduled the corresponding R-TWT scheduling information corresponds to an AP corresponding to a non-transmitted BSSID. For example, the BSSID Index subfield may be included in the restricted TWT parameter set field only when the corresponding broadcast TWT parameter set field is considered a restricted TWT parameter set field (i.e., a broadcast TWT parameter set field with the broadcast TWT recommendation subfield set to 4).

As another example, the BSSID Index subfield may be included only when a restricted TWT traffic info subfield is present in a restricted TWT parameter set field.

The STA may determine that a restricted TWT parameter set field with a value of 3 in a restricted TWT schedule info subfield in a broadcast TWT info subfield is scheduled by an AP corresponding to a non-transmitted BSSID, but if the BSSID Index subfield is not present, the STA must additionally check the restricted TWT parameter set field in the broadcast TWT element in the multiple BSSID element to determine which AP among the APs corresponding to multiple non-transmitted BSSIDs was scheduled.

However, according to the proposed method of the present disclosure, if the BSSID index subfield exists, based on the value of the restricted TWT schedule info subfield being 3, the STA can quickly identify which non-transmitted BSSID corresponds to the R-TWT schedule information scheduled by the AP through the value of the BSSID index subfield in the restricted TWT parameter set field.

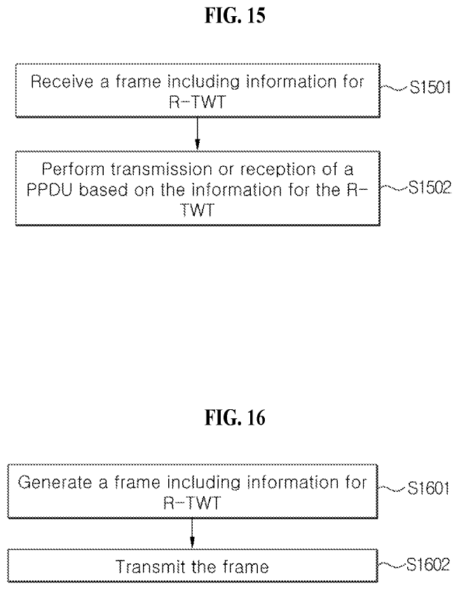

FIG. 15 illustrates an operation of an STA for a method for transmitting and receiving information about a restricted target wake time according to an embodiment of the present disclosure.

FIG. 15 illustrates the operation of a STA device based on the previously proposed methods. The example in FIG. 15 is provided for convenience of explanation and does not limit the scope of the present disclosure. Some of the step(s) illustrated in FIG. 15 may be omitted depending on the situation and/or setting.

Referring to FIG. 15, a STA receives a frame including information for R-TWT from a first AP (S1501).

Here, as described above, a AP corresponding to a transmitted BSSID can announce information about R-TWT scheduled by the AP corresponding to the transmitted BSSID and/or a AP corresponding to a non-transmitted BSSID, and the first AP may refer to the AP corresponding to the transmitted BSSID.

Here, the frame may include BSSID-related information for identifying a BSSID corresponding to the second AP in relation to the information for the R-TWT.

Based on the frame including information indicating that the information for the R-TWT is for one or more APs corresponding to a non-transmitted BSSID, the BSSID-related information may be included in the frame. In this case, it may be determined whether the information for the R-TWT is for the second AP among the one or more APs based on the BSSID-related information.

Furthermore, the frame may be a beacon frame or a probe response frame.

The frame may include a broadcast TWT parameter set field corresponding to information for the R-TWT, and a BSS index subfield corresponding to the BSSID-related information may be included in the broadcast TWT parameter set field. Here, the frame may include information about one or more R-TWTs (i.e., one or more broadcast TWT parameter set fields). In other words, a TWT element in the frame may include information about one or more R-TWTs (i.e., one or more broadcast TWT parameter set fields). Here, the broadcast TWT parameter set field may correspond to a restricted TWT parameter set field in which a broadcast TWT recommendation subfield is indicated as 4.

Based on a value of the restricted TWT schedule info subfield in the broadcast TWT info subfield in the broadcast TWT parameter set being 3, it may be indicated that the broadcast TWT parameter set field is for the one or more APs corresponding to the non-transmitted BSSID. In this case, the BSS index subfield may be located last in the broadcast TWT parameter set field. Alternatively, based on the inclusion of the restricted traffic info subfield in the broadcast TWT parameter set field, the BSS index subfield may be located before the restricted traffic info subfield.

Based on the information for the R-TWT, the STA performs transmission or reception of a PPDU with the second AP (S1502).

Here, the second AP corresponds to a non-transmitted AP indicated by the frame, and may correspond to an AP to which the STA is associated. In other words, the STA can identify that the schedule information for the R-TWT is scheduled by the second AP through the value of the non-transmitted BSSID specified/included in the schedule information for the R-TWT scheduled by the AP corresponding to the non-transmitted BSSID included in the frame. Then, the STA can form an R-TWT membership for the second AP, and transmit or receive a PPDU according to the information on the R-TWT (e.g., R-TWT SP).

Here, the PPDU can be composed of a legacy portion, a SIG portion (e.g., U-SIG, UHR-SIG, etc.), an STF portion (e.g., UHR-STF), an LTF portion (e.g., UHR-LTF), and a data portion.

All or part of any part (i.e., field) may be divided into multiple subparts/subfields. Each field (and its subfields) may be transmitted in units of 4 us*N (where Nis an integer).

Additionally, a guard interval (GI) may be included. A common subcarrier frequency spacing value (delta_f=312.5 kHz/N or 312.5 kHz*N, where N is an integer) may be applied to all fields, or a first delta_f may be applied to a first part (e.g., all of the legacy part, all/part of the SIG part), and a second delta_f (e.g., a value smaller than the first delta_f) may be applied to all/part of the remaining parts.

Some of the above-described fields may be omitted, and the order of the fields may be changed in various ways. For example, the subfields of the signal part may be placed before the STF part, and the remaining subfields of the SIG part may be placed after the STF part.

The legacy part described above may include at least one of the conventional Non-HT Short Training Field (L-STF), Non-HT Long Training Field (L-LTF), and Non-HT Signal Field (L-SIG).

The SIG part described above (e.g., including the U-SIG field, UHR-SIG field, etc.) may include various control information for the transmitted PPDU. For example, it may include the STF part, the LTF part, and control information for data decoding.

The STF part described above may include an STF sequence.

The LTF part described above may include a training field (i.e., an LTF sequence) for channel estimation.

The data part described above may include user data and packets for an upper layer. Here, the plurality of PSDUs described above may be included in the data part.

The method described in the example of FIG. 15 may be performed by the first device (100) of FIG. 1. For example, one or more processors (102) of the first device (100) of FIG. 1 may be configured to receive a frame and transmit or receive a PPDU via the transceiver(s) (106). Furthermore, one or more memories (104) of the first device (100) may store commands for performing the method described in the example of FIG. 15 or the examples described above when executed by one or more processors (202).

FIG. 16 illustrates an operation of an AP for a method for transmitting and receiving information about a restricted target wake time according to an embodiment of the present disclosure.

FIG. 16 illustrates the operation of an AP device based on the previously proposed methods. The example in FIG. 16 is provided for convenience of explanation and does not limit the scope of the present disclosure. Some of the step(s) illustrated in FIG. 16 may be omitted depending on the situation and/or setting.

Referring to FIG. 16, an AP (hereinafter referred to as a first AP) generates a frame including information for an R-TWT related to a second AP (S1601).

Here, as described above, a AP corresponding to a transmitted BSSID can announce information about R-TWT scheduled by the AP corresponding to the transmitted BSSID and/or a AP corresponding to a non-transmitted BSSID, and the first AP may refer to the AP corresponding to the transmitted BSSID.

Here, the first AP can distinguish whether the schedule information is a pre-formed R-TWT or an individual/broadcast TWT schedule. And, if the first AP determines that the schedule information is for R-TWT and not for individual/broadcast TWT, it can distinguish whether the schedule information of the R-TWT is scheduled by an AP corresponding to a non-transmitted BSSID or an AP corresponding to a transmitted BSSID. If the schedule information of the R-TWT is scheduled by an AP corresponding to a non-transmitted BSSID, the first AP can generate a frame by adding a value/information that can identify the non-transmitted BSSID to the R-TWT schedule information.

That is, the frame may include BSSID-related information for identifying a BSSID corresponding to the second AP in relation to the information for the R-TWT.

Based on the frame including information indicating that the information for the R-TWT is for one or more APs corresponding to a non-transmitted BSSID, the BSSID-related information may be included in the frame. In this case, it may be determined whether the information for the R-TWT is for the second AP among the one or more APs based on the BSSID-related information.

Furthermore, the frame may be a beacon frame or a probe response frame.

The frame may include a broadcast TWT parameter set field corresponding to information for the R-TWT, and a BSS index subfield corresponding to the BSSID-related information may be included in the broadcast TWT parameter set field. Here, the frame may include information about one or more R-TWTs (i.e., one or more broadcast TWT parameter set fields). In other words, a TWT element in the frame may include information about one or more R-TWTs (i.e., one or more broadcast TWT parameter set fields). Here, the broadcast TWT parameter set field may correspond to a restricted TWT parameter set field in which a broadcast TWT recommendation subfield is indicated as 4.

Based on a value of the restricted TWT schedule info subfield in the broadcast TWT info subfield in the broadcast TWT parameter set being 3, it may be indicated that the broadcast TWT parameter set field is for the one or more APs corresponding to the non-transmitted BSSID. In this case, the BSS index subfield may be located last in the broadcast TWT parameter set field. Alternatively, based on the inclusion of the restricted traffic info subfield in the broadcast TWT parameter set field, the BSS index subfield may be located before the restricted traffic info subfield.

The first AP transmits a frame (S1602).

For example, if the frame is a beacon frame, the first AP may transmit the frame in a broadcast scheme. As another example, if the frame is a probe response frame, the first AP may transmit the frame to the STA that transmitted the probe request frame as a response to the probe request frame.

If the STA that received the frame confirms that the information is for R-TWT for the second AP corresponding to the non-transmitted BSSID to which it is associated, the STA can transmit or receive PPDU with the second AP based on the information for R-TWT.

Here, the second AP corresponds to a non-transmitted AP indicated by the frame, and may correspond to an AP to which the STA is associated. In other words, the STA can identify that the schedule information for the R-TWT is scheduled by the second AP through the value of the non-transmitted BSSID specified/included in the schedule information for the R-TWT scheduled by the AP corresponding to the non-transmitted BSSID included in the frame. Then, the STA can form an R-TWT membership for the second AP, and transmit or receive a PPDU according to the information on the R-TWT (e.g., R-TWT SP).

Here, the PPDU can be composed of a legacy portion, a SIG portion (e.g., U-SIG, UHR-SIG, etc.), an STF portion (e.g., UHR-STF), an LTF portion (e.g., UHR-LTF), and a data portion.

All or part of any part (i.e., field) may be divided into multiple subparts/subfields. Each field (and its subfields) may be transmitted in units of 4 us*N (where Nis an integer).

Additionally, a guard interval (GI) may be included. A common subcarrier frequency spacing value (delta_f=312.5 kHz/N or 312.5 kHz*N, where N is an integer) may be applied to all fields, or a first delta_f may be applied to a first part (e.g., all of the legacy part, all/part of the SIG part), and a second delta_f (e.g., a value smaller than the first delta_f) may be applied to all/part of the remaining parts.

Some of the above-described fields may be omitted, and the order of the fields may be changed in various ways. For example, the subfields of the signal part may be placed before the STF part, and the remaining subfields of the SIG part may be placed after the STF part.

The legacy part described above may include at least one of the conventional Non-HT Short Training Field (L-STF), Non-HT Long Training Field (L-LTF), and Non-HT Signal Field (L-SIG).

The SIG part described above (e.g., including the U-SIG field, UHR-SIG field, etc.) may include various control information for the transmitted PPDU. For example, it may include the STF part, the LTF part, and control information for data decoding.

The STF part described above may include an STF sequence.

The LTF part described above may include a training field (i.e., an LTF sequence) for channel estimation.

The data part described above may include user data and packets for an upper layer. Here, the plurality of PSDUs described above may be included in the data part.

The method described in the example of FIG. 16 may be performed by the second device (200) of FIG. 1. For example, one or more processors (202) of the second device (200) of FIG. 1 may be configured to generate a frame and transmit the frame via the transceiver(s) (206). Furthermore, one or more memories (204) of the second device (200) may store commands for performing the method described in the example of FIG. 16 or the examples described above when executed by one or more processors (202).

In order for an STA associated with an AP corresponding to a non-transmitted BSSID in a conventional wireless LAN system to confirm that the R-TWT schedule information is for the AP, an operation of additionally confirming multiple BSSID elements in addition to the R-TWT schedule information is required. However, according to the examples of the present disclosure, unlike this, an STA can confirm that the R-TWT schedule information is for the AP corresponding to the non-transmitted BSSID to which it is associated with only the R-TWT schedule information. Accordingly, since it is possible to quickly identify which non-transmitted BSSID the R-TWT schedule information is scheduled by which AP, the efficiency in the process of forming an R-TWT membership can be improved.

Embodiments described above are that elements and features of the present disclosure are combined in a predetermined form. Each element or feature should be considered to be optional unless otherwise explicitly mentioned. Each element or feature may be implemented in a form that it is not combined with other element or feature. In addition, an embodiment of the present disclosure may include combining a part of elements and/or features. An order of operations described in embodiments of the present disclosure may be changed. Some elements or features of one embodiment may be included in other embodiment or may be substituted with a corresponding element or a feature of other embodiment. It is clear that an embodiment may include combining claims without an explicit dependency relationship in claims or may be included as a new claim by amendment after application.

It is clear to a person skilled in the pertinent art that the present disclosure may be implemented in other specific form in a scope not going beyond an essential feature of the present disclosure. Accordingly, the above-described detailed description should not be restrictively construed in every aspect and should be considered to be illustrative. A scope of the present disclosure should be determined by reasonable construction of an attached claim and all changes within an equivalent scope of the present disclosure are included in a scope of the present disclosure.

A scope of the present disclosure includes software or machine-executable commands (e.g., an operating system, an application, a firmware, a program, etc.) which execute an operation according to a method of various embodiments in a device or a computer and a non-transitory computer-readable medium that such a software or a command, etc. are stored and are executable in a device or a computer. A command which may be used to program a processing system performing a feature described in the present disclosure may be stored in a storage medium or a computer-readable storage medium and a feature described in the present disclosure may be implemented by using a computer program product including such a storage medium. A storage medium may include a high-speed random-access memory such as DRAM, SRAM, DDR RAM or other random-access solid state memory device, but it is not limited thereto, and it may include a nonvolatile memory such as one or more magnetic disk storage devices, optical disk storage devices, flash memory devices or other nonvolatile solid state storage devices. A memory optionally includes one or more storage devices positioned remotely from processor(s). A memory or alternatively, nonvolatile memory device(s) in a memory include a non-transitory computer-readable storage medium. A feature described in the present disclosure may be stored in any one of machine-readable mediums to control a hardware of a processing system and may be integrated into a software and/or a firmware which allows a processing system to interact with other mechanism utilizing a result from an embodiment of the present disclosure. Such a software or a firmware may include an application code, a device driver, an operating system and an execution environment/container, but it is not limited thereto.

### INDUSTRIAL AVAILABILITY

A method proposed by the present disclosure is mainly described based on an example applied to an IEEE 802.11-based system, 5G system, but may be applied to various WLAN or wireless communication systems other than the IEEE 802.11-based system.

1. A method performed by a station (STA) in a wireless local area network (WLAN) system, the method comprising:
receiving a frame including information for a restricted target wake time (R-TWT) from a first access point (AP); and
transmitting or receiving a physical protocol data unit (PPDU) with a second AP based on the information for the R-TWT,
wherein the frame includes BSSID-related information for identifying a basic service set identifier (BSSID) corresponding to the second AP in relation to the information for the R-TWT.

2. The method of claim 1, wherein the BSSID-related information is included in the frame based on the frame including information indicating that the information for the R-TWT is for one or more APs corresponding to a non-transmitted basic service set identifier (BSSID).

3. The method of claim 2, wherein wherein the BSSID-related information identifies whether the information for the R-TWT corresponds to the second AP among the one or more APs.

4. The method of claim 3, wherein the frame includes a broadcast TWT parameter set field corresponding to the information for the R-TWT, and
wherein a BSS index subfield corresponding to the BSSID-related information is included in the broadcast TWT parameter set field.

5. The method of claim 4, wherein the broadcast TWT parameter set field is indicated to be for the one or more APs corresponding to a non-transmitted BSSID based on a value of a restricted TWT schedule info subfield in a broadcast TWT info subfield in the broadcast TWT parameter set field being equal to 3.

6. The method of claim 4, wherein the BSS index subfield is located last in the broadcast TWT parameter set field.

7. The method of claim 4, wherein based on a restricted traffic info subfield being included in the broadcast TWT parameter set field, the BSS index subfield is located before the restricted traffic info subfield.

8. The method of claim 1, wherein the frame is a beacon frame or a probe response frame.

9. A station (STA) device in a wireless local area network (WLAN) system, the device comprising:
at least one transceiver; and
at least one processor connected to the at least one transceiver,
wherein the at least one processor configured to:
receive a frame including information for a restricted target wake time (R-TWT) from a first access point (AP); and
transmit or receiving a physical protocol data unit (PPDU) with a second AP based on the information for the R-TWT,
wherein the frame includes BSSID-related information for identifying a basic service set identifier (BSSID) corresponding to the second AP in relation to the information for the R-TWT.

10. (canceled)

11. A first access point (AP) device in a wireless local area network (WLAN) system, the device comprising:
at least one transceiver; and
at least one processor connected to the at least one transceiver,
wherein the at least one processor configured to:
generate a frame including information for a restricted target wake time (R-TWT) related to a second AP; and
transmit the frame,
wherein the frame includes BSSID-related information for identifying a basic service set identifier (BSSID) corresponding to the second AP in relation to the information for the R-TWT.

12-13. (canceled)
